(19) United States
(12) Patent Application Publication
(10) Pub. No.: US 2014/0370478 A1
(43) Pub. Date: Dec. 18, 2014

(54) Molecular modeling kit

(71) Applicant: Ragen Pfeiffer, Kelkheim (DE)

(72) Inventor: Ragen Pfeiffer, Kelkheim (DE)

(21) Appl. No.: 14/361,660

(22) PCT Filed: Nov. 29, 2012
(86) PCT No.: PCT/EP2012/073993

§ 371 Date: May 29, 2014

(30) Foreign Application Priority Data
Nov. 29, 2011 (DE) 102011120272.6

(51) Int. Cl. G09B 23/26; G09B 1/40

(52) U.S. Cl. CPC G09B 23/26; G09B 1/40
USPC 434/278

(57) ABSTRACT

The invention concerns a valence-electron-model in shape of a molecular-building-set and its use for early learning and teaching purposes at schools and universities. In the molecular-building-set each electron is preferentially enabled to form a chemical bond and is represented by a radical-neutral-connecting-element, each plus-charge is represented by plus-charge-connecting-elements and each minus-charge is represented by a minus-charge-connecting-element. Free electron-pairs are represented by two electron-representations in shape of an electron-pair-representation. Binding-forces between electron-pairs and basic-atomic-body-representations are represented by electron-pair-connecting-elements and basic-atomic-body-connecting-elements. Radical-neutral-connecting-elements are in a preferred embodiment shaped as radical-neutral-plugs with C3n-rotational-symmetry. Atomic-representations of each element have an individual characteristic set of electron-representations and the above named connecting-elements, which show the characteristic chemical properties of each individual element. Therefore it is for the first time possible to understand an atom or respectively an element as a unit with all its binding properties. Lewis-formula can directly be recognized and drawn of the represented molecules.

### 1.0 SHORT DESCRIPTION MOLECULAR-BUILDING-SET

The invention concerns a valence electron model in shape of a molecular-building-set as well as its usage in kindergartens as a toy for early learning, learning purposes and for the use in schools and universities as molecular-building-set. The molecular-building-set is so far unique as, preferably each electron which is capable to form a chemical bond is represented by a radical-neutral-connecting-element, every plus-charge is represented by a plus-charge-connecting-element and every minus-charge is represented by a minus-charge-connecting-element. Free electron-pairs are represented as a pair of two electron-representations in shape of one electron-pair-representation. Bond-forces between electron-pairs and basic-atomic-bodies are represented by electron-pair-connecting-elements and basic-atomic-body-connecting-elements. The radical-neutral-connecting-elements are in a preferred version shaped as radical-neutral-plugs with a C₃ₙ-rotational-symmetry. Atomic-representations of each single element have as a consequence an individual characteristic set of electron-representations and the above mentioned connecting-elements, which are the basis for the characteristical chemical properties of each individual chemical element. Lewis-formula can be directly recognized and painted off the represented atoms and molecules. The molecular-building-set described in the invention uses therefore as a result 5 kinds of connecting-elements.

### 1.1 TERMINOLOGICAL DEFINITIONS

### Universally Valid Chemical Terminology:

Universally valid terminology of chemistry like for example minus-charge, plus-charge, atoms, electrons, bonds, free electron-pairs do not describe parts of molecular-building-set but real structures of atoms and molecules.

Patent relevant representations of atoms and their parts:

As far as representations are concerned in the text, it concerns pieces of the molecular-building-set, e.g. accordingly the representation of a water-molecule consists out of a representation of an oxygen atom, which is connected to two hydrogen representations.

Basic-atomic-body-representations (chap. 3, FIG. 4, 5, 23-40) are used in the molecular-building-set as a symbol for atomic cores, which comprise the building bricks of the atomic nuclei and the electrons of the inner shells and which comprise in some cases the chemically non relevant electrons of the outer shell. Basic-atomic-body-representations are in a preferred embodiment represented by ball-shaped or polyhedral bodies.

Connecting-elements are elements or connecting-devices or plugs, which enable the mutual attachment of pieces of the molecular-building-set, in a way that they can be detached again. These connections generally represent bonds, forces and interactions between different atoms. The connection of the connecting-elements with each other can be based on very different plugging-, adhesion- or connecting-principles. The concrete solution of the plugging-, adhesion- or connecting-principles, this means whether plugs, magnets, hook-and-loop-fasteners or other connecting systems are used, is not relevant for the invention, but the allocation of a certain connecting-principals to a chemical bond (e.g. covalent or ionic) or chemical interaction (e.g. H-bridges) as well as the compatibility of connecting-principles with each other. In a preferred embodiment different forces, bonds or interactions are represented by different plugging-, adhesion- or connecting-principles or are represented by different plugging-, adhesion- or connecting-devices.

A plus-charge-connecting-element (chap. 5.0, 5.1, FIG. 4, 5) represents the plus-charges of the basic-atomic-body-representations. A minus-charge-connecting-element (chap. 5.0, 5.1, FIG. 7, 8) represents the negative charges of the electron-representations. Always one plus-charge-connecting-element and one minus-charge-connecting-element can be attached to each other respectively being connected to each other. In case a plus-charge-connecting-element and a minus-charge-connecting-element are attached to each other, it represents a neutralization of charge. The connection of plus-charge-connecting-elements and minus-charge-connecting-elements with each other is based on a male/female connecting-principle and as well based on a male/female connecting-element. These are either plugging-contacts with pins and recesses (according to the principle of plug and socket), magnets with north-pole and south-pole, hook-and-loop-fastener with hooks and loops, gecko-adherences with suction-cups and faces, connections with hook and eye or connecting-elements, which are based on any other imaginable male/female connecting-principles. Preferable are magnetic connections, which very clearly represent, that only opposite poles can be connected to each other and two identical positive charges as well as two identical negative charges are rejecting each other.

Plus-charge-connecting-elements in the preferred version are permanently connected to the basic-atomic-bodies. Minus-charge-connecting-elements are permanently connected to the electron-representations.

Thereby it is possible that the as female defined part of the connecting-principles is either always on the side of the basic-atomic-body and as a consequence the as male defined part is always on the side of the electron-representation or the as male defined part of the connecting-principles is either always on the side of the basic-atomic-body and as a consequence of this the as female defined part is always on the side of the electron-representation.

Particularly plus-charge-connecting-elements and minus-charge-connecting-elements of the preferred embodiment cannot be attached to radical-neutral-connecting-elements, basic-atomic-body-connecting-elements and electron-pair-connecting-elements of the molecular-building-set, to demonstrate, that these are in each case completely different bonds and forces, whereas every plus-charge-connecting-element of every basic-atomic-body can be connected to every minus-charge-connecting-element, whereas minus-charge-connecting-elements can not be connected with each other and plus-charge-connecting-elements can not be connected with each other.

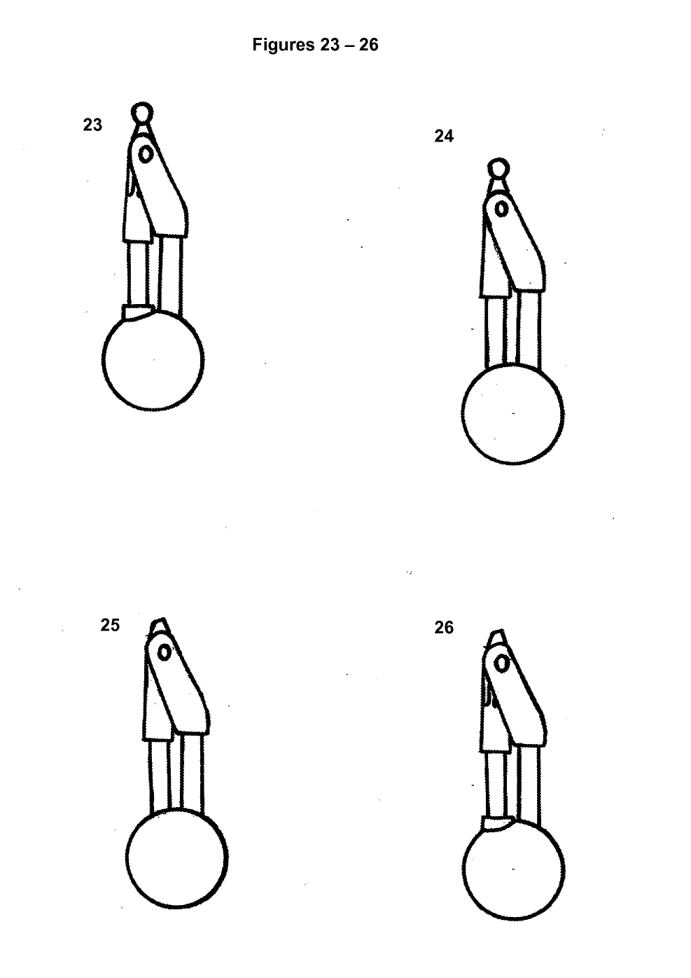

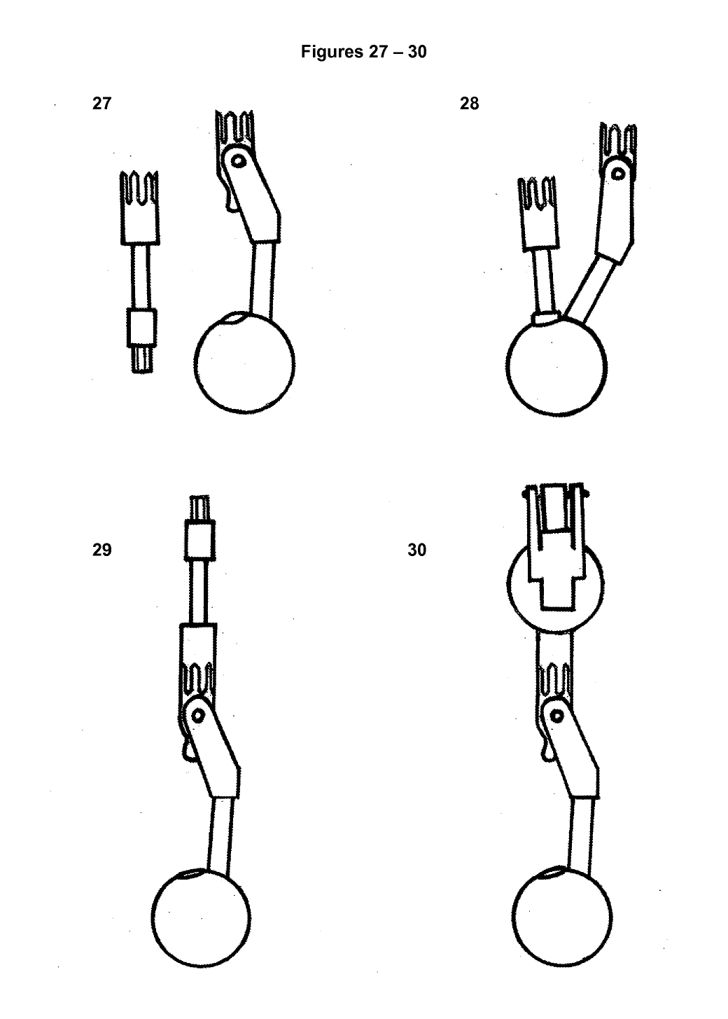

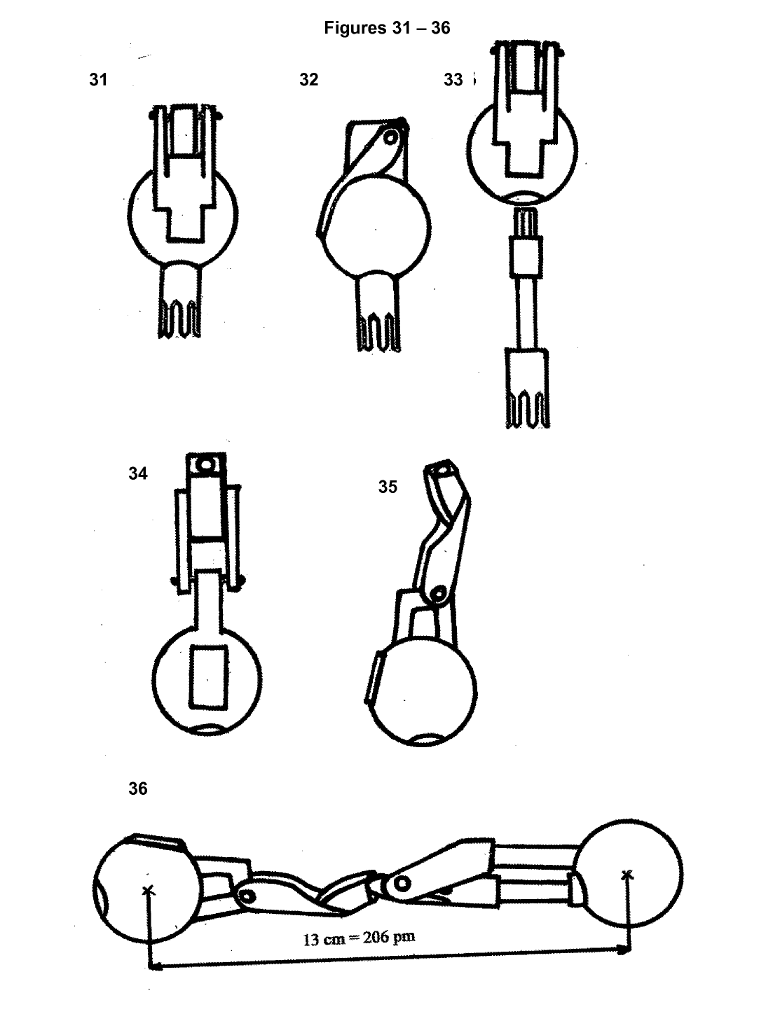

The Basic-Atomic-Body-Connecting-Elements (chap. 7.0, 7.1, 7.2, 7.3, 7.4, FIG. 31-40) represent coordination-positions of atomic-cores, onto which electron-pair-representations can be attached via their electron-pair-connecting-element. An electron-pair-connecting-element (chap. 6.0, FIGS. 23-24) represents with electron-pair-representations a position, with which it can be attached to basic-atomic-body-connecting-elements. Always one basic-atomic-body-connecting-element and one electron-pair-connecting-element can be attached or connected to each other.

The connection of electron-pair-connecting-elements and basic-atomic-body-connecting-elements with each other is based on a male/female connecting-principle. It can be either ball-couplings with ball and ball-pivot, plugging-contact with pins and recesses (like the principle of plug and socket), magnets with north-pole and south-pole, hook-and-loop-fastener with hooks and loops, gecko-attachment with suction-cups and faces, connections with hook and eye or connecting-elements, which are based on any other male/female connecting-principles.

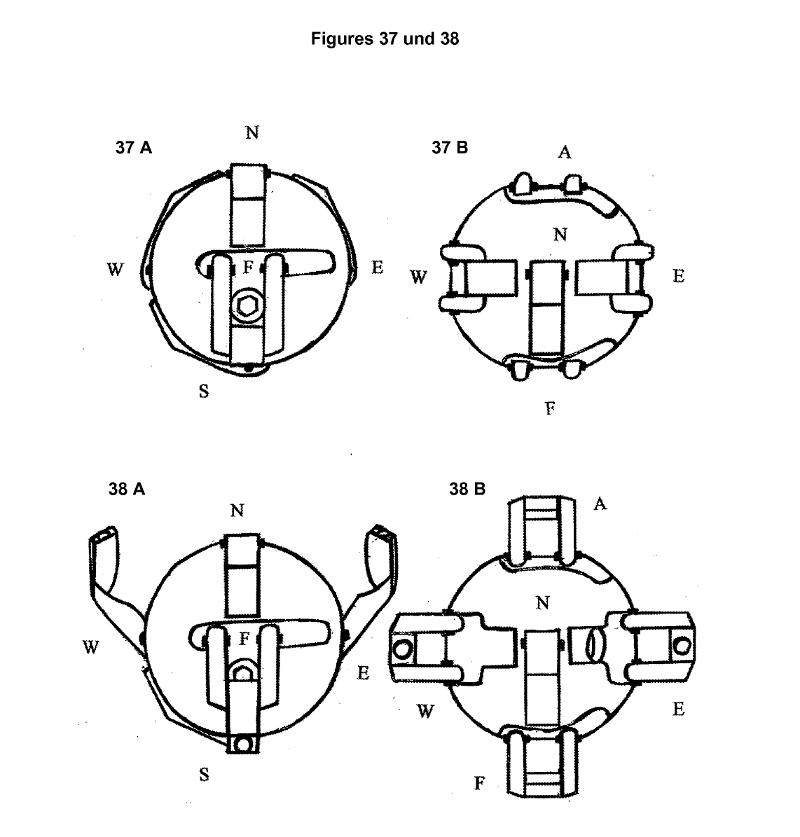

The basic-atomic-body-connecting-elements are preferably permanently fixed to one single pin or several pins. These pins, which carry the basic-atomic-body-connecting-elements, can on the other end be firmly connected to a basic-atomic-body with a pivoted joint. At metal-atomic-representations the firm connection can be of such a nature, that using six out-foldable electron-pair-coupling-recesses the most important coordination-configurations like, tetragonal-bipyramidal, trigonal-bipyramidal, tetrahedral, tetragonal-planar and trigonal-planar are representable (chap. 7.1-7.4, e.g. in FIGS. 37-40 in the preferred embodiment represented with electron-pair-coupling-recesses).

Electron-pair-connecting-elements are in the preferred embodiment permanently connected to electron-pair-representations or pins, which can be connected to basic-atomic-body-connecting-elements of the basic-atomic-body. Thereby it is possible that the as female defined part is either always on the side of the basic-atomic-body and the as male defined part is always on the side of the electron-representation or the as male defined part is either always on the side of the basic-atomic-body and the as female defined part is always on the side of the electron-representation.

Basic-atomic-body-connecting-elements and electron-pair-connecting-elements can in the preferred embodiment not be connected to radical-neutral-connecting-elements, plus-charge-connecting-elements and minus-charge-connecting-elements of the molecular-building-set, to demonstrate, that these are completely different kinds of bonds and forces.

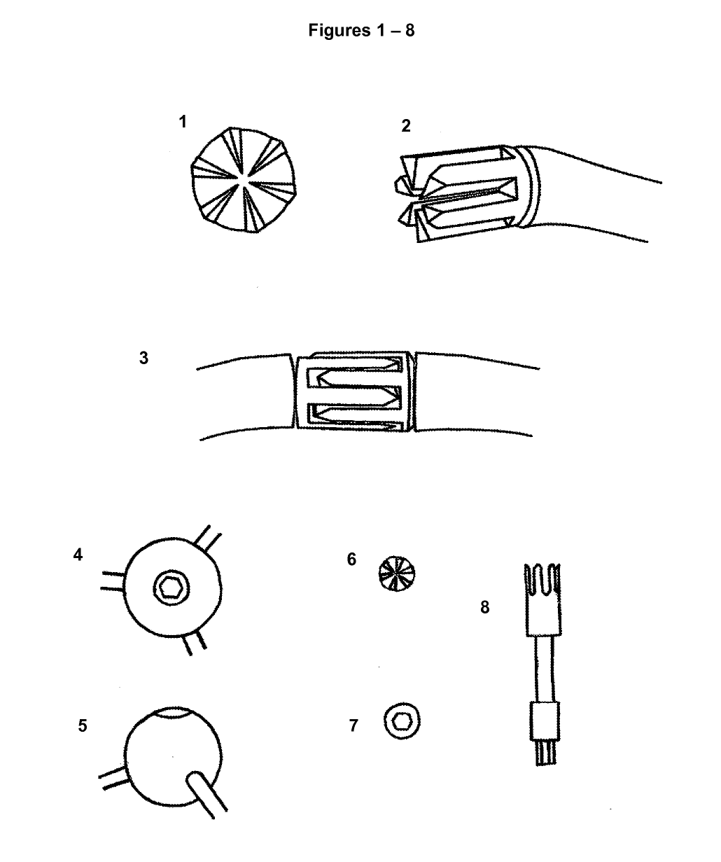

Radical-neutral-connecting-elements (chap. 4.0, 4.1, 4.2, FIG. 1, 2, 3, 6, 8, 16, 17, 18) are those positions with which electron-representations can be connected to each other. Decisive is thereby that each radical-neutral-connecting-element of one electron-representation can be connected to any other radical-neutral-connecting-element of different electron-representations of the molecular-building-set.

The radical-neutral-connecting-element can be either a radical-neutral-plug (in this document synonymously named as null-plug) with preferably geometrically positioned pins and recesses for reception and insertion of pins of a second radical-neutral-plug, or a hook-and-loop-fastener with loops and hooks always each on both sides of the hook-and-loop-fastener, this means that hooks and loops are each on both sides placed directly besides of each other respectively on each of both sides alternatively positioned in geometrical patterns, or neutral-magnet-connections which north-poles and south-poles which alternate on each of both sides in geometrical patterns, or neutral-gecko-adherence-plugs on which suction-cups and faces alternate on each of both sides and preferentially alternate in geometrical patterns, or bayonet-lock-tube-couplings with different possible numbers of interlocking rails or connecting-elements, or further thinkable connecting-possibilities based on neutral connecting- or adherence-principles. The radical-neutral-connecting-elements are in so far special, that every radical-neutral-connecting-element can be connected to every other radical-neutral-connecting-element. This means that it is no male/female principle, but any two radical-neutral-connecting-elements can be connected to each other. It is characteristic for radical-neutral-connecting-elements that any radical-neutral-connecting-element can be connected to any other radical-neutral-connecting-element.

In the preferred embodiment radical-neutral-connecting-elements can only be connected to other radical-neutral-connecting-elements and not connected to plus-charge-connecting-elements, minus-charge-connecting-elements, basic-atomic-body-connecting-elements and electron-pair-connecting-elements of the molecular-building-Set, to demonstrate, that these are in each case completely different bonds and forces.

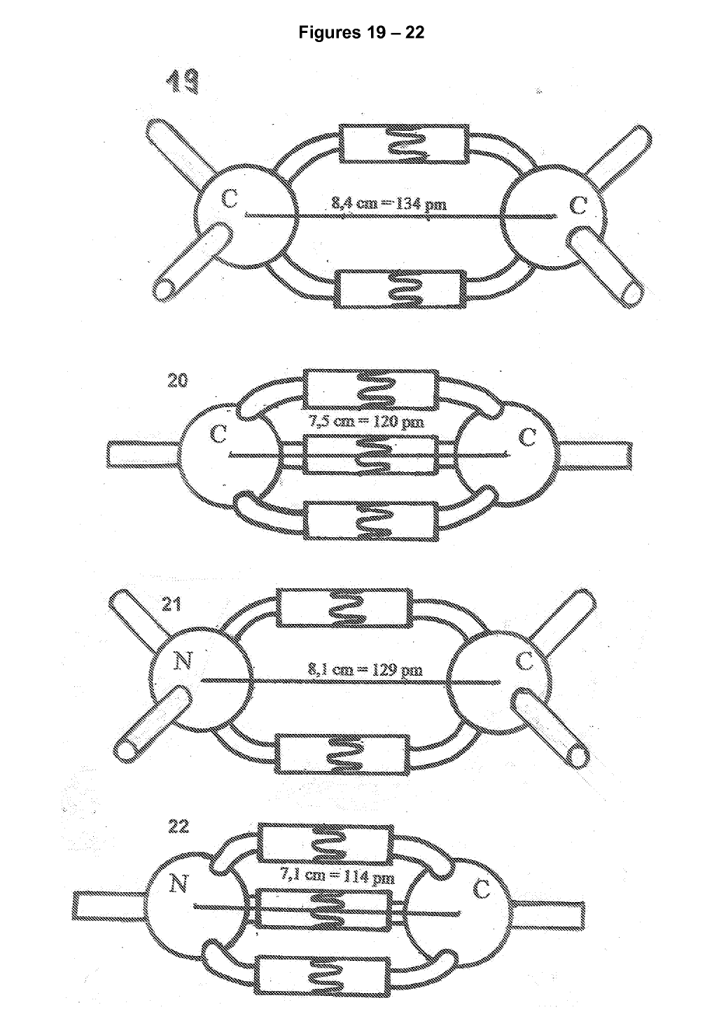

C₃ₙ-Radical-Neutral-Connecting-Elements (FIG. 1, 2, 12, 14) are radical-neutral-connecting-elements with a C₃ₙ-rotational-symmetry. Therein n can be an integer of 1 until 20. The case of n=1 results in a C₃-symmetry, which like e.g. a Mercedes-Star by turning around the rotational axis by a third of 360°, what corresponds to 120°, it images itself again. Using C₃ₙ-radical-neutral-connecting-elements with a C₃ₙ-symmetry it is possible, that atomic-representations which are connected to each other form staggered- or eclipsed-conformations, which are the common representations of organic molecules and their stereo-chemical construction. This is a result of the tetrahedral structure of atoms. In addition the eclipsed conformation is the basis for the kind of multiple bonds used in the molecular-building-set. In this case after the formation of the single bond further radical-neutral-connecting-elements positioned in the eclipsed position are connected to each other, what leads exactly to planarly shaped molecules in the case of the double-bond (FIGS. 19 and 21) and what leads to exactly linearly shaped molecules in the case of the triple-bond (FIGS. 20 and 22). If the eclipsed conformation is not precise the possibly formed double-bond-representation is twisted and it is impossible to get a precise planar molecular-representation in the case of a double-bond-representation or to get a precise linear molecular-representation in the case of the triple-bond-representation.

In the preferred embodiment of the C₃ₙ-radical-neutral-connecting-element is n=2 which is as a consequence a C₆-radical-neutral-connecting-element which is in the preferred embodiment a C₆-radical-neutral-plug (FIG. 1,2,6). Thus either the staggered as well as the eclipsed positions can be alternatingly represented, what enables the common stereo-chemical representations of organic chemistry and in addition enables the representation of double- and triple-bonds.

C₃ₙ-radical-neutral-connecting-elements, preferably a C₃ₙ-radical-neutral-plug, thus are positions with which electron-representations can be connected to each other. It is decisive therein, that each C₃ₙ-radical-neutral-connecting-element of an electron-representation can be connected to any other C₃ₙ-radical-neutral-connecting-element of other electron-representations of the molecular-building-set. The positions of adherence, pins or elements of other adherence principles in the C₃ₙ-radical-neutral-connecting-element is preferably arranged in a C₃ₙ-geometry, in which for example the male and female elements of the adherence principle can be annularly arranged. This is shown on the example of the plug (FIG. 1,2, 12 at the example of C₃ₙ-radical-neutral-plugs) or on a triangular pattern like in FIG. 14. The C₃ₙ-radical-neutral-connecting-element can be either a C₃ₙ-radical-neutral-plug (in this document as well synonymously named C₃ₙ-null-plug) with preferably C₃ₙ-geometrically arranged pins and recesses for insertion and take in of the pins of a second C₃ₙ-radical-neutral-plug, or C₃ₙ-neutral-hook-and-loop-fasteners with loops and hooks on each of both hook-and-loop-fasteners, this means the hooks and loops are on each of both sides directly arranged besides of each other respectively on each of both sides preferably alternatingly arranged in C₃ₙ-geometrical patterns, or C₃ₙ-neutral-magnetic-connections on which north-pole and south-pole on each of both sides which preferably alternate in C₃ₙ-geometrical patterns, or C₃ₙ-neutral-gecko-adherence-plugs on which suction-cups and faces are placed on each of both sides and which preferably alternate in C₃ₙ-geometrical patterns, or C₃ₙ-bayonet-lock-tube-couplings with different possible numbers of interlocking rails or connecting-elements, or any further thinkable neutral C₃ₙ-connecting- or C₃ₙ-adherence-principles which are based on C₃ₙ-connecting-possibilities.

C₃ₙ-radical-neutral-connecting-elements are in so far special, that every radical-neutral-connecting-element can be connected to every other radical-neutral-connecting-element. This means that it is no male/female principle, but any two C₃ₙ-radical-neutral-connecting-elements can be connected to each other. The C₃ₙ-radical-neutral-connecting-elements of the molecular-building-set thus are arbitrarily combinable with each other.

In the preferred embodiment C₃ₙ-radical-neutral-connecting-elements can only be connected to other C₃ₙ-radical-neutral-connecting-elements and not to plus-charge-connecting-elements, minus-charge-connecting-elements, basic-atomic-body-connecting-elements and electron-pair-connecting-elements of the molecular-construction-sets, to demonstrate, that these are in each case completely different bonds and forces.

Electron-representations (chap. 5.0, 5.1, FIG. 1, 2, 3, 8, 9, 10, 26, 27, 33) carry each one radical-neutral-connecting-element and are either as firmly located electron-representation firmly connected to the basic-atomic-body-representation or can as detachable electron-representations with their minus-charge-connecting-element be connected to the plus-charge-connecting-elements of basic-atomic-body-representations.

In the preferred embodiment there are different kinds of firmly connected electron-representations:
As electron-representation of a single electron in which the radical-neutral-connecting-element is preferably connected to the basic-atomic-body by a flexible binding-tube or is directly firmly connected to the basic atomic-body.
Electron-representation as part of electron-pair-representations, in which the radical-neutral-connecting-element is firmly connected on a pivoting-element, which is clipped into a holder profile with a pin, around which the pivoted-link can turn, which is firmly connected to the basic-atomic-body via a flexible binding-tube.

Detachable Electron-Representations or Representations of free Electrons (chap 5.0, FIG. 8, 27, 33) are preferably a building block of the molecular-building-set and consist of a radical-neutral-connecting-element and a minus-charge-connecting-element. These two connecting-elements can be either directly connected or be connected via a binding-tube or a flexible connecting-tube firmly connected to each other. This electron-representation which corresponds to the invention thus consists of radical-neutral-connecting-element which is connected to a minus-charge-connecting-element.

The present invention thus concerns as well an electron-representation as part of the molecular-building-set, at which a free electron is represented by a radical-neutral-connecting-element, preferably by a radical-neutral-plug, connected to a minus-charge-connecting-element, which is preferably represented by a minus-charge-plug, at which the radical-neutral-connecting-element, respectively the radical-neutral-plug, is a connecting-element, which can be connected to any other radical-neutral-connecting-element and at which the minus-charge-connecting-element respectively the minus-charge-plug is a male/female connecting-element, which can only be connected to the corresponding counter-connecting-element, the plus-charge-connection-element, respectively the plus-charge-plug, of the basic-atomic-body.

In other words the herein described invention concerns an electron-representation as part of the molecular-building-set, at which a free electron is represented by a radical-neutral-connecting-element, which is preferably a radical-neutral-plug, which is connected to a minus-charge-connection-element, which is preferably a minus-charge-plug, at which the radical-neutral-connecting-element, respectively the radical-neutral-plug is a connection-element, which can be connected to any other connection element of this type and the minus-charge-connecting-element, respectively the minus-charge-plug, is a male/female connecting-element, which only can be connected to the corresponding plus-charge-connecting-element respectively to the plus-charge-plug of the basic-atomic-body.

Herein the term “connected to”, means, that these both connecting-elements or plugs in the representation of the free electron are firmly connected to each other, thus are non detachably connected to each other.

The connection between the radical-neutral-connecting-element, preferably a radical-neutral-plug, and the minus-charge-connecting-element, preferably a minus-charge-plug is achieved by a middle section, preferentially a longish middle section, further preferred a flexible or bendable middle section, even further a longish, flexible or bendable middle section, at which opposing ends the two different connecting-elements respectively plugs are firmly connected. Preferably the radical-neutral-connecting-element contains the herein described C₃- or C₃ₙ-symmetry. As middle section especially a flexible or bendable pipe, bar or tube is preferred.

The representation of the free electron is connectable via the radical-neutral-connecting-element, respectively the radical-neutral-plug with a radical-neutral-connecting-element, respectively a radical-neutral-plug of another electron-representation and connectable via the minus-charge-connecting-element, respectively the minus-charge-plug with a plus-charge-connection-element, respectively a plus-charge-plug of a basic-atomic-body.

A preferred embodiment of the present invention concerns an electron-representation as part of the molecular-building-set, at which a free electron is represented by a radical-neutral-plug which is connected to a minus-charge-element via a flexible or bendable middle section, at which the radical-neutral-plug is a connecting-element, which can be connected to each other connecting-element of this type and the minus-charge-plug is a male/female connecting-element, that can only be connected to the corresponding plus-charge-plug of the basic-atomic-body.

In other words the preferred embodiment of the present invention concerns an electron-representation as part of the molecular-building-set, at which a free electron is represented by a radical-neutral-plug which is connected to a minus-charge-element via a flexible or bendable middle section, at which the radical-neutral-plug is a plug, which can be connected to each other radical-neutral-plug and the minus-charge-plug is a male/female-plug that can only be connected to the corresponding plus-charge-plug of the basic-atomic-body.

Electron-pair-representations (chap. 6.0, FIGS. 22-29) are in a preferred embodiment represented as connection of two electron-representations, which are detachably connected or firmly connected to a basic-atomic-body.

Thus the present invention concerns as well the representation of an electron-pair, at which the representation of an electron-pair contains one electron-representation, which is connected to the second electron-representation of the represented electron-pair via a radical-neutral-connecting-element and which is via a minus-charge-connecting-element connected to the plus-charge-connecting-element of the basic-atomic-body.

radical-neutral-plugs are preferred embodiments of radical-neutral-connecting-elements (chap. 4.0, 4.1, 4.2, FIG. 1, 2, 3, 6, 8, 9, 10, 16-22).

Radical-neutral-plugs (in this document synonymously as well named null-plug) consist preferably of multiple pins, which are fixed to a plate (like e.g. in the embodiments of FIGS. 1, 2, 3, 6, 8, 12-15 represented) and between the pins are recesses, which have about the same volume like the pins and are able to take in the pins of another or second radical-neutral-plug. Each radical-neutral-plug has preferably a sub-division in shape of pins and recesses, which consists of one pin, two pins, three pins, four pins, five pins, six pins, seven pins, eight pins, nine pins, ten pins, eleven pins, twelve pins, thirteen pins, fourteen pins, fifteen pins, sixteen pins, seventeen pins, eighteen pins or a higher number of pins.

Especially preferred are three, six, nine, twelve pins or a number of pins, or a number of pins which is a multiple of three.

The dowels are additionally preferably annularly arranged on a circular disc and stand preferably vertically on this circular disc. Out of this follows that the pins preferably taper towards the middle of the circular disc (e.g. in the preferred embodiment with 6 pins in FIGS. 1, 2, 3, 6, 8 represented).

The pins of a radical-neutral-plug can besides of the preferred annular embodiment in this way be arranged on a disc, in such a way that the pins of one part of the plug are on the positions of the black squares of checker-board-pattern and the recesses are on the positions the white squares of such a checker-board-pattern (FIG. 15).

A further possible way of arranging the pins of the radical-neutral-plug is based on equilateral triangles as basic pattern for the positions of the pins, at which every pin is a part of up to six triangles and a connected pattern of equilateral triangles is generated (FIG. 14).

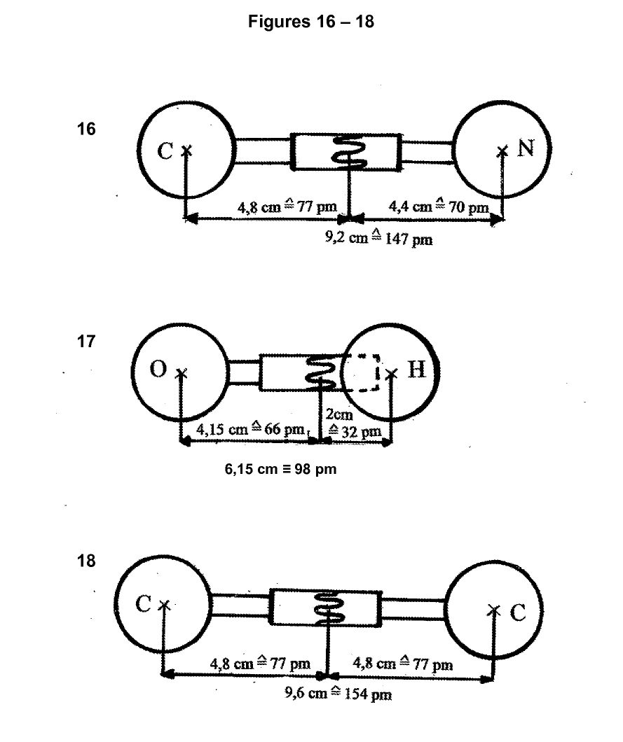

The effective true to scale bond-distance and the effective proportionate bond-distance are described in Chapter 4.0 and the FIGS. 16 and 18.

C₃ₙ-Radical-neutral-plugs (FIG. 1, 2, 12, 14) are radical-neutral-plugs of a preferred embodiment which have a C₃ₙ-rotational-symmetry. Therein n can be an integer of 1 until 20. The case of n=1 results as a consequence in a C₃-symmetry, which like e.g. a Mercedes-Star by turning around the rotational axis by a third of 360°, what corresponds to 120°, images itself again. By using C₃ₙ-radical-neutral-plugs with a C₃ₙ-rotational-symmetry it is possible, that atomic-representations which are connected to each in a staggered- or eclipsed-conformation, which are the common representations of organic molecules and their stereo-chemical construction. This is a result of the tetrahedral structure of Atoms. In addition the eclipsed conformation is the basis for the kind of multiple bonds used in the molecular-building-set. In this case after the formation of the single bond further radical-neutral-plugs which positioned in the eclipsed position are connected to each other, which then leads to exactly planarly shaped molecule-representations in the case of the double-bond-representation (FIGS. 19 and 21) and to exactly linearly shaped molecule-representations in the case of the tipple-bond-representation (FIGS. 20 and 22). If the eclipsed conformation is not precisely formed the possibly formed double-bond-representation is twisted and it is impossible to get a precise planar molecular-representation in the case of a double-bond-representation or to get a precise linear molecular-representation in the case of the triple-bond-representation.

In the preferred embodiment of the C₃ₙ-radical-neutral-plug n=2 and this is as a consequence a C₆-radical-neutral-plug (FIG. 1,2,6). Thus either the staggered as well as the eclipsed positions are alternatingly representable, what therefore enables the common stereo-chemical representations of organic Chemistry and in addition enables the representation of double- and triple-bonds.

C₃ₙ-radical-neutral-plugs in the preferred embodiment thus are the positions with which electron-representations can be connected to each other. Decisive is therein, that each C₃ₙ-radical-neutral-plug of an electron-representation can be connected to any other C₃ₙ-radical-neutral-plug of other electron-representations of the molecular-building-set.

The arrangement of the pins in the C₃ₙ-radical-neutral-plug is preferably arranged in a C₃ₙ-geometry, in which for example the male/female elements of the adherence principle can be annularly arranged. This is shown with the example of the plug (FIG. 1,2, 12 at the example of C₃ₙ-radical-neutral-plugs) or with a triangular pattern like in FIG. 14.

The C₃ₙ-radical-neutral-plug has preferably a C₃ₙ-geometrically arranged pins and recesses for the take in and insertion of the pins of a second C₃ₙ-radical-neutral-plug.

C₃ₙ-radical-neutral-plugs are in that respect special, that every radical-neutral-plug can be connected to any other radical-neutral-plug of the molecular-building-set. This means that it is no male/female principle, but any two C₃ₙ-radical-neutral-plugs can be connected to each other. The C₃ₙ-radical-neutral-plugs thus are arbitrarily combinable with each other.

In the preferred embodiment C₃ₙ-radical-neutral-plugs can only be connected to other C₃ₙ-radical-neutral-plugs and not to plus-charge-connecting-elements, minus-charge-connecting-elements, basic-atomic-body-connecting-elements and electron-pair-connecting-elements of the molecular-building-sets, to demonstrate, that these are in each case completely different bonds and forces.

Minus-charge-plugs are a preferred embodiment of the minus-charge-connecting-elements (chap. 5.0, 5.1, FIGS. 7 and 8) and consist of one or several pins, which are connected to the flexible element of the electron-representation. The pins have preferably a geometry and further preferably a rotational-symmetry. The rotational-symmetry is preferably a multiple of three. Especially preferred is the embodiment with a C6-rotational-symmetry. Minus-charge-plugs can as well be shaped as a ball of a ball-coupling.

Plus-charge-plugs are a preferred embodiment of plus-charge-connecting-elements (chap. 5.0, 5.1, FIGS. 4, 5, 27, 33, 37-40) are represented as recess, which can take the pin or pins of the minus-charge-plug in and therefore it shell have the same rotational-symmetry like the minus-charge-plug (FIG. 4, 5).

As a consequence the plus-charge-plug can as well be an intake or recess for the plug in of the ball of the minus-charge-plug.

Besides of these preferred embodiments of the minus-charge-plugs and plus-charge-plugs can the side which is defined as female be either always on the side of the basic-atomic-body and the side which is defined to be male be always on the side of electron-representations or the side of the connecting principle which is defined as male is either always on the side of the basic-atomic-body and the side which is defined as female is in each case on the side of electron-representations.

Electron-pair-couplings-plug is the preferred embodiment of the electron-pair-connecting-elements (chap. 6.0, FIG. 23, 24), which are preferably shaped as ball of a ball-coupling and are then called electron-pair-coupling-ball. Besides of this preferred embodiment plugs of the electron-pair-coupling-plug can be represented by single of several pins.

Basic-atomic-body-coupling-plug is the preferred embodiment of basic-atomic-body-connecting-elements (chap. 7.0, 7.1, 7.2, 7.3, 7.4, FIG. 31-40), which are preferably represented as ball-pivot of a ball-coupling and are then called basic-atomic-body-ball-coupling-recess. Besides of this preferred embodiment plugs of the electron-pair-coupling-plugs, which can as well be represented as recess or recesses, which respectively fit to the pins of the electron-pair-coupling-plug.

Besides of this preferred embodiment of the basic-atomic-body-coupling-plugs and electron-pair-coupling-plug can the side which is defined to be female either always be on the side of the basic-atomic-body and the side which is defined to be male lies always on the side of electron-representations or the side of the bonding principle which is defined to be male is either always on the side of the basic-atomic-body and the side which is defined to be female is at any time on the side of electron-pair-representations.

### 2.0 STATE OF THE ART

From the state of the art several molecular-building-sets are known, with such molecular-building-sets however only very non detailed molecules can be represented. On these atomic-models the positions of atoms are represented in the right way, but the electrons and their bindings adhesive forces and the adhesive forces of the cores and charges are only represented in an insufficient way. “The “Minit-Building-Set” that is sod by the company Crochane in three versions “organic chemistry”, “biochemisty” and “inorganic chemistry” and “Chrystal Chemistry”, shows the standard color-code of the elements, but with this learning-toy only an insufficient understanding of the bonding-relations in chemical molecules can be achieved. To represent a correct binding-length between two different kinds of atom, the connecting-tubes have to be cut with a knife or pair of scissors. A true to scale representation of the binding-length can only be achieved by active action of the user before the construction of a molecule. Another big problem is the representation of ions, Complex-bonds and hydrogen-bridges. At the mentioned Cochanes-System the binding-relations in boron-compound for example can only insufficiently be represented with trigonal-planar atomic-centers and thus the actual binding-relations are not represented in the right way. Also all plug-connections are equipped with male/female-plugs, which in addition can not be related to any chemical function.

Besides of the above mentioned “Minit”-molecular-construction-system shows that US-patent U.S. Pat. No. 5,030,103 only rudimentary building pieces for the construction of simple molecule-representations, for example a pentagonal-bipyramidal basic-body with fixed axial-positions, at which the atoms of the equatorial-level can be shifted in the direction of both axial-points. With this molecular-building-set simple sequences of reactions can be represented. It is possible to show single steps of a nucleophilic substitution on the basis of SN₁ or a mechanism of second order (SN₂). Thus simple dynamic processes are representable, but with model chemical bonds between two atoms cannot be sufficiently be explained.

Besides of this learning toys exist, that are focused, to cover special fields of chemistry. In this way U.S. Pat. No. 4,014,110 A shows a crystal-grid-system and WO 2006080871 A1 clearly shows the construction of atoms, at which electrons, protons and neutrons are represented. With all molecular-building-sets a deeper comprehension of the electron-pair-binding or a ionic-binding is only superficially achieved. All above mentioned molecular-building-sets are only insufficiently able to impart the relation between free electrons respectively free electron-pairs as well as numbers of bindings, the coordination number, as well a the three dimensional position of the substituents, this means sterical position, to the learning person.

The task of the invention thus is to present a molecular-building-set that is adequate for all age-groups in the execution of a valence-electron-model, that can can clearly represent the basic building-principles of chemical compounds and simple reaction-mechanisms.

Above all the relation between electrons and their forces and atomic-cores and their forces and their mutual interplay shell be represented. Especially with it the binding between two electron for the formation of binding and non-binding electron-pairs, the bindings between two single electrons with atomic-cores in shape of plus-minus-charge-interaction and between electron-pairs with atomic-cores in shape of hydrogen-bonds, Lewis-acid-base-interactions, complex-bindings and ionic-bindings shell be illustrated.

This challenge is solved by the technical content of the independent patent claims. Preferred executions of the invention are in the dependent patent claims, of the description, the figures as well as the examples specified.

### DESCRIPTION

The present invention concerns a molecular-building-set which contains or comprises electron-representations and basic-atomic-body-representations, at which an electron of a covalent bond is represented by a radical-neutral-connecting-element and each connecting-element of this type is connectable with each connecting-element of the same type.

According to the invention the radical-neutral-connecting-element is a connecting-element, that does not follow the plus-minus or male/female principle, but is instead shaped in that way, that only one type of connecting-element exists and this connecting-element is connectable with any other connecting-element of this type.

The present invention concerns as well a molecular-building-set that contains or comprises electron-representations and basic-atomic-body-representations, at which an electron of a covalent bond is represented by a radical-neutral-connecting-element with a C₃ₙ-symmetry, in which n is a integer from 1 until 20 and every connecting-element of this type can be connected to each connecting-element of the same type.

The radical-neutral-connecting-element is preferably a radical-neutral-plug as herein disclosed.

Preferably the electron-representation consists of one connecting-element or a radical-neutral-connecting-element or radical-neutral-plug with a C₃ₙ-symmetry and a minus-charge-connecting-element in shape of a male/female connecting-element. The minus-charge-connecting-element is preferably a minus-charge-plug in shape of a male/female plug.

n within the C₃ₙ-symmetry is preferably an integer of 1-15, preferably of 1-10, further preferred of 1-8, even further preferred of 1-6, even further preferred of 1-5, even further preferred of 1-4, even further preferred 2, 3 or 4, and especially preferred 2.

The present invention concerns as well a molecular-building-set, at which a radical is represented by a C₃ₙ-radical-neutral-connecting-element, a positive charge is represented by a plus-charge-connecting-element, a negative charge is represented by a minus-charge-connecting-element and a chemical interaction is represented by an electron-pair-connecting-element and a basic-atomic-body-connecting-element, at which the C₃ₙ-radical-neutral-connecting-element is a type of connecting-element, which can be connected to any other connecting-element of this type, at which the plus-charge-connecting-element and the minus-charge-connecting-element are types of connecting-elements of a first male/female combination of connecting-elements and the electron-pair-connecting-element and the basic-atomic-body-connecting-element are two types of connecting-elements of a second male/female combination of connecting-elements.

The present invention further concerns a molecular building set comprising electron representations and atomic representations, at which an charge-conjunction is represented by a connection of a plus-charge-connecting-element preferably a plus-charge-plug with a minus-charge-connecting-element, preferably a minus-charge-plug, and a covalent bond is represented by a connection of two radical-neutral-connecting-elements, preferably two radical-neutral-plugs, and a hydrogen bond or a coordination-bond is represented by a connection of an electron-pair-connecting-element preferably an electron-pair-coupling-plug with a basic-atomic-body-connecting-element, preferably represented by a basic-atomic-body-coupling-plug, at which an charge-conjunction is represented by a male/female connection principle and the coordination bond or hydrogen bond is represented by another male/female connecting principle and the covalent bond is represented by binding principle, at which each radical-neutral-connecting element preferably a radical-neutral-plug that can be connected to any other radical-neutral-connecting-element, preferably a radical-neutral-plug.

The term “can be represented by another male/female-connecting-principle” describes the context, that charge-conjunctions are represented by one kind of a male/female-connecting-principle and coordination-bonds or hydrogen-bridges are represented by a second kind of a male/female-connecting principle, which is not compatible with the first kind.

Embodiments for diverse male/female-connecting-principles are in this document disclosed like e.g. a pin and a corresponding recess for the intake of this pin or a ball and a corresponding ball-holder for intake of the ball. Both are male/female-connecting-principles but they are not compatible with each other. That means the ball does not fit into the recess for the pin.

Differently phrased the present invention concerns a molecular-building-set comprising electron-representations and basic-atomic-body-representations, at which an charge-conjunction is represented by a connection of a plus-charge-connecting-element, preferably a plus-charge-plug with a minus-charge-connecting-element, preferably a minus-charge-plug and a covalent bond is represented by a connection of two radical-neutral-connecting-elements, preferably of two radical-neutral-plugs and a hydrogen-bridge or a coordination-bond of an electron-pair-connecting-element, preferably an electron-pair-coupling-plug with a basic-atomic-body-connecting-element, preferably a basic-atomic-body-coupling-plug, at which an charge-conjunction is represented by two male/female-connecting-elements preferably male/female-plugs of a first kind and the coordination-bond as well as the hydrogen-bridge are formed by two male/female-connecting-elements, preferably male/female-plugs of a second kind that is not compatible with the first kind and the radical-neutral-connecting-elements, preferably radical-neutral-plugs can be connected to any other radical-neutral-connecting-element, preferably radical-neutral-plug, but are not compatible with the male/female-connecting-elements preferably male/female-plugs.

The molecular-building-set according to the invention thus contains three kinds of connecting-elements, which are not compatible with each other, this means that they cannot be connected to each other and a bond can only be formed by the two partners (male and female or neutral, this means 2 identical connecting-elements respectively connecting-plugs), in a way that as well a radical disjunction of a bond as well as an ionic disjunction of a bond can be represented.

Herein a radical is represented as a single not connected radical-neutral-connecting-element, preferably radical-neutral-plug and an ionic charge is represented by a single not connected plus-charge-connecting-element preferably plus-charge-plug for a positive charge and a minus-charge-connecting-element, preferably minus-charge-plug for a negative charge.

### Radical-Neutral-Connecting-Elements

Because of this combination of different connecting-elements for the user it is for the first time possible to distinguish between different forces and bonds and ate them to relate them to different connecting-element-systems.

Besides of this feature the radical-neutral-connecting-elements in the preferred embodiment do have a C₃ₙ-rotational-Symmetry with n=1, 2, 3, . . . , 20 along the binding-axis.

Like in this document used the term C₃ₙ-rotational-symmetry means, that this connecting-element has along the binding-axis of the covalent bond which is to be represented a three-numbered rotational-axis or a multiple (n) of this three-numbered rotational-axis, at which n preferably is an integer from 1 until 20. Preferred are rotational-symmetries of 3 and a multiple of 3 like e.g. C₃-, C₆-, C₉-, C₁₂-, C₁₅-, C₁₈-, C₂₁-, C₂₄-, C₂₇-, C₃₀-rotational-symmetries or higher rotational-symmetries of this series. Such rotational symmetries can e.g. be indicated as C₃ₙ with n=1, 2, 3, 4, 5, 6, 7, 8, 9, 10 etc. or as C₃ₙ with n=1−20, preferred n=1−5, further preferred n=1, 2 or 3 and especially preferred n=2.

Thus another preferred embodiment of the present invention is directed towards a molecular-building-set containing or comprising electron-representations and basic-atomic-body-representations, at which one electron of a covalent bond is represented by a connecting-element with a C₃ₙ-rotational symmetry, with n from 1 until 20, preferred from 1 until 4 and each C₃ₙ-radical-neutral-connecting-element of this type can be connected with any C₃ₙ-radical-neutral-connecting-element of the same type.

Only because of the C₃ₙ-rotational-symmetry either all three different staggered or all three different eclipsed positions can be obtained or the C₆-symmetry which is based on the C₃ₙ-symmetry all 6 different staggered and eclipsed positions, which result from the tetrahedral shape of the atoms, become possible, at which the eclipsed positions are the start-positions for untwisted multiple-bonds.

According to the invention the radical-neutral-connecting-elements have a C₃ₙ-rotational-symmetry, this means with a three-numbered, a six-numbered, a nine-numbered etc. rotational-axis.

### Preferred Embodiment as Radical-Neutral-Plug

In another preferred embodiment the radical-neutral-connecting-element is represented as radical-neutral-plug and contains pins and recesses (FIG. 1) between the pins, at which the recesses serve for the intake of the pins of a second radical-neutral-plug (FIG. 3) and the pins extend along the longitudinal-axis of the plugging-connection out of both radical-neutral-plugs (FIG. 16-18). Further the radical-neutral-plug is preferably shaped as a circular disc with thereon vertically arranged pins (FIG. 1).

Further it is preferred that the circular disc with its vertically arranged pins is shaped turnably around the longitudinal axis of the plugging-connection out of two radical-neutral-plugs

Especially preferred is an embodiment as radical-neutral-plug. In an especially preferred embodiment the radical-neutral-connecting-element is represented as C₃ₙ-radical-neutral-plug (with n as an integer from 1 until 20) and has pins and recesses (FIG. 1) between the pins, at which the recesses are used for take in of the pins of a second radical-neutral-plug that have a C₃ₙ-rotational-symmetry (FIG. 3) and the pins are extended along the longitudinal axis of the plugging-connection of both radical-neutral-plugs (FIG. 16-18).

Further the radical-neutral-plug is preferably shaped as a circular disc with thereon vertically arranged pins with a C₃ₙ-rotational-symmetry (FIG. 1).

Further more the circular disc is preferably shaped with the thereon vertically arranged pins is turnable around the longitudinal axis of the plugging contact out of two C₃ₙ-radical-neutral-plugs, which possess positions for click into place with C₃ₙ-rotational-symmetry in which the compound can be in eclipsed and staggered positions.

### Electron-Representations

Further the present invention concerns a molecular-building-set comprising electron-representations (FIG. 8) at which each electron-representation consists of one radical-neutral-connecting-element (FIG. 22) connected with a minus-charge-connecting-element, at which each radical-neutral-connecting-element is a type of connecting-element, that can be connected with each other connecting-element of this type and the minus-charge-connecting-element is a male-female connecting-element-type that can only be connected to the corresponding counter-connecting-element, which is the plus-charge-connecting-element.

So far no molecular-building-set is known, in which a building-block can be found that represents an electron. The molecular-building-set like in the invention presents for the first time electron-representations, that are represented by a radical-neutral-connecting-element for representation of the electron respectively of the radical and a minus-charge-connecting-element to symbolize the negative-charge.

Thus the electron is represented in the preferred embodiment by a radical-neutral-connecting-element in shape of a radical-neutral-plug that can be combined with any plug of the same type and a minus-charge-connecting-element in shape of a male plug or a female plug of a male/female plug-combination.

As male/female plug-combination or as male plug respectively female plugs are described, which can only be connected to the corresponding counter-plug, like for instance a USB-plug (male) that only fits in the corresponding USB-socket (female), at which two USB-plugs (male) or as well two USB-sockets (female) are not connectable to each other.

Preferably between the radical-neutral-connecting-element and the minus-charge-connecting-element of the electron-representation is a flexible, movable or bendable binding-link or middle-section (FIG. 19-22) in shape of a tube, pipe, cylinder, bar or chain.

According to the present invention a radical, a positive charge, a negative charge or a chemical interaction is in the preferred embodiment represented by different connecting-elements in shape of different plugs, at which only the plugs, that represent a radical but no other plug-types can be connected to each other. Thereby these are neutral-plugs, this means each plug of this type can be connected to each plug of this type. Plugs that represent a negative charge, can only be connected with plugs that represent a positive charge, but not connected to different plug-types. Plugs that represent a chemical interaction, like e.g. H-bridges, Lewis-acid-base-interactions, complex-bindings and ionic-bonds. Are only connectable with each other as male/female-plugs but not with other plug-types.

Thus a radical is preferably represented by a radical-neutral-connecting-element, a positive charge is represented by a plus-charge-connecting-element a negative charge is represented by a minus-charge-connecting-element and a chemical interaction is represented by an electron-pair-connecting-element and a basic-atomic-body-connecting-element, at which the radical-neutral-connecting-element is a connecting-element-type that can be connected to any other connecting-element of this type, at which a plus-charge-connecting-element and a minus-charge-connecting-element are two connecting-element-types of a first male/female connecting-element-combination and at which the electron-pair-connecting-element and the basic-atomic-body-connecting-element are two connecting-element-types of a second male/female connecting-element-combination.

Thus only radical-neutral-connecting-elements are connectable with each other but cannot be connected to minus-charge-connecting-elements or plus-charge-connecting elements or electron-pair-connecting-elements or basic-atomic-body-connecting-elements. A minus-charge-connecting-element can only be connected to a plus-charge-connecting-element but not be connected to a radical-neutral-connecting-element or a basic-atomic-body-connecting-element or an electron-pair-connecting-element. An electron-pair-connecting-element can only be connected to a basic-atomic-body-connecting-element but not be connected to a radical-neutral-connecting-element or a minus-charge-connecting-element or a plus-charge-connecting-element.

The term “chemical interaction” describes any kind of interaction that can be represented as binding that is no charge-disjunction, charge-conjunction and is no formation or separation of a covalent bond.

In a preferred embodiment the present invention concerns a molecular-building-set, at which an electron-representation consists of a C₃ₙ-radical-neutral-connecting-element with a C₃ₙ-rotational-symmetry, at which n is a whole number of 1 until 20 and a minus-charge-connecting-element in shape of a male/female connecting-element. Thus according to the invention a single or a free electron represented by two different connecting-elements, which are preferably located on both ends of a longish connecting-piece like e.g. a pipe, a tube, a bolt, a bar, a pole or anything like that. Preferred is again C₃ₙ-rotational-symmetry like defined above for the connecting-element that represents the radical-neutral-connecting-element and thus symbolizes the radical part of an electron. The charge-content is symbolized by another connecting-element, the minus-charge-connecting-element, which is shaped in form of a male/female connecting-element. This means each electron-representation carries in the preferable embodiment a radical-neutral-connecting-element in shape of a connecting-element with a C₃ₙ-rotational-symmetry and a minus-charge-connecting-element in shape of a male connecting-element, which are connected to each other via a longish connecting piece. The connecting-element with the C₃ₙ-rotational-symmetry can be connected to any other connecting-element of the same type, but not with the male/female connecting-element for representing the positive and the negative charge. Is the negative charge represented by a male connecting element, it can only be connected with a female connecting-element that symbolizes the positive charge e.g. at the basic-atomic-body-representation, but it can not be connected to a second male connecting-element. The same applies to female connecting-elements, which can not be connected with each other, but only be connected to a male connecting-element.

Molecular-construction-sets with an electron-representation, in which the radical-part is represented by a connecting-element with a C₃ₙ-rotational-symmetry and the charge-part by a male/female connecting-element are not known in the state of art.

Preferable Embodiment of Electron-Representation with Radical-Neutral-Plug

In a further preferred embodiment of an electron-representation the radical-neutral-connecting-element is represented as radical-neutral-plug and has pins and recesses (FIG. 1) between the pins, at which the recesses are used for the insertion of the pins of a second radical-neutral-plug (FIG. 3) and the pins extend along the longitudinal axis of the plug-connection of both radical-neutral-plugs (FIG. 16-18). The minus-charge-connecting-element in this preferred embodiment is based on an arbitrary male/female connecting-element-system.

Further preferred the radical-neutral-plug is shaped as a circular disc with thereon vertically arranged pins (FIG. 1).

Furthermore preferred the circular disc with thereon vertically arranged pins is build rotatably around the longitudinal axis of the plug-connection of two radical-neutral-plugs.

Especially Preferred is the Embodiment of the Electron-Representation with C₃ₙ-Radical-Neutral-Plug

In an especially preferred embodiment of the electron-representation the radical-neutral-connecting-element is represented as C₃ₙ-radical-neutral-plug and has pins and recesses (FIG. 1) between the pins, at which the recesses are used for the take in of the pins of a second radical-neutral-plug which have a C₃ₙ-rotational-symmetry (FIG. 3) and the pins extend along the longitudinal axis of the plug-connection of both radical-neutral-plugs (FIG. 16-18).

Further preferred the radical-neutral-plug is shaped as a circular disc with thereon vertically arranged pins with a C₃ₙ-rotational-symmetry (FIG. 1).

Furthermore preferred the circular disc with the vertically arranged pins is build rotatably around the longitudinal axis of the plug-connection of two C₃ₙ-radical-neutral-plugs which have click-in-place-positions in C₃ₙ-rotational-symmetry in which the binding can form staggered and eclipsed positions.

### Three Different Connecting-Element-Systems for Three Different Forces

Preferably the connecting-element-combination of plus-charge-connecting-element and minus-charge-connecting-element is a plug-contact of a pin and a recess, a magnet with north-pole and south-pole, a hook and loop-fastener of hooks and loops, a gecko-adherence with suction-cups and faces, a connection of hook and eye, a plus-minus-plug-connection or any other male/female connecting-principle.

A male/female connecting-principle always demands two kinds of connecting-elements, which can be connected to each other (e.g. antenna-cable and antenna-cable-socket, where only a male plug can be connected to a female plug)

Preferably the connecting-element-combination of electron-pair-connecting element and basic-atomic-body-connecting-element is a plug-contact of a pin and a recess, a ball and a ball-holder, a magnet with north-pole and south-pole, a hook and loop-fastener of hooks and loops, a gecko-adherence with suction-cups and faces, a connection of hook and eye, a plus-minus-plug-connection or any other male/female connecting-principle.

Only the radical-neutral-connecting-element does not follow the male-female-connecting-principle but follows a neutral connecting principle, this means only one connection-element-type does exist (called radical-neutral-connecting-element or null-connecting-element) which can be connected to any other connecting-element of this type (that means with any radical-neutral-connecting-element or null-connecting-element). In the preferred embodiment the radical-neutral-connecting-elements are built as radical-neutral-plugs, at which these plugs have a certain geometry to be able to interlock.

The connecting-element-combination of two radical-neutral-connecting-elements is a plug-contact of two plug with either pins and recesses for reception of the pins of a corresponding second plug, or a neutral-hook-and-loop-fastener with loops and hooks either on both sides of the hook-and-loop-fastener, or a neutral-magnet-connection with north-poles and south-poles on each of both magnets, or a neutral-gecko-adherence-plugs with suction-cups and faces on each of both sides of the neutral-gecko-adherence-plug, or a bayonet-lock-tube-coupling with interlocking rails on both sides of the bayonet-lock-tube-coupling, or another neutral connecting- or adherence-principle.

The radical-neutral-connecting-element is either a radical-neutral-plug with geometrically arranged pins and recesses for reception and insertion of the pins of another radical-neutral-plug, or neutral-hook-and-loop-fasteners with loops and hooks always each on both with each other connectable sides of the hook-and-loop-fastener, this means the loops and hooks are attached to each of both with each other connectable sides, or neutral-magnet-connections, at which north-poles and south-poles are on each of both with each other connectable sides of the magnet, or neutral-gecko-adherence-plugs with suction-cups and faces on each of both with each other connectable sides, or bayonet-lock-tube-couplings with interlocking rails on both with each other connectable couplings, or on further thinkable connecting-possibilities which are based on neutral connecting- or adherence-principle.

A plus-minus-adherence-principle or a plus-minus-plug-principle describes the same as a male-female-connecting-principle, namely two kinds of connecting-elements at which two different but not two identical connecting-elements are connectable with each other,

### Three Different Connecting-Element-Systems for Three Different Forces

In a preferred embodiment, as the used connecting-element-systems, three different plug types are used for representing different bindings and interactions, namely radical-neutral-plugs, which have a C₃ₙ-rotational-symmetry (n=1-20) in the preferred embodiment, a male/female plug of type I (as plus-charge-connecting-element and minus-charge-connecting-element), a male-female plug of type II (as electron-pair-connecting-element and basic-atomic-body-connecting-element). Only plugs of the same type can be connected to each other, at which at the plugs of type I and type II only male and female can be connected to each other.

### Double-Bond-Representations

With the molecular-building-set like in the invention, it is possible to true to scale represent the length of a covalent bond (single-bond, double-bond and triple-bond) and the distance of a chemical interaction (FIG. 16-18, 19-22).

### Representations of Free Electron-Pairs

An electron-pair-representation that is enabled for chemical reactions and located on a basic-atomic-body-representation is preferably represented by two with each other connected radical-neutral-connecting-elements, which are part of two electron-representations, which are connected or adhered to the same basic-atomic-body-representation (FIGS. 23 and 26).

Further one atomic-representation of an element has preferably as many radical-neutral-connecting-elements, as this element possesses valence-electrons (FIG. 41).

Further preferred is, if the by two with each other represented radical-neutral-connecting-elements represented electron-pair-representation that is connected to a basic-atomic-body-representation with a connection of a plus-charge-connecting-element and a minus-charge-connecting-element (FIG. 29):

### Preferred Embodiment of Minus-Charge-Connecting-Elements

A minus-charge-connecting-element is preferably represented by a minus-charge-plug by a round, triangular, tetragonal, pentagonal, hexagonal, nonagonal or dodecagonal coloredly marked pin (FIGS. 8 bottom and 29 top) and a plus-charge-connecting-element is preferably represented by a round, triangular, tetragonal, pentagonal, hexagonal, nonagonal or dodecagonal coloredly marked recess (FIG. 4) for the take in of the pin. With the help of the color the existence of a charge is directly recognizable and the positive and negative charge disappear optically by plugging together of the plus-charge-plug with the minus-charge-plug.

### Flexible Connecting-Tubes Shortening Double-Bond

It is further preferable, that a radical-neutral-connecting-element is connected to a basic-atomic-body-representation via a flexible link (FIG. 19-22) or a radical-neutral-connecting-element is connected to a minus-charge-connecting-element via flexible link (FIG. 8). As a flexible link or middle section a flexible, movable or bendable tubule or a flexible, movable or bendable bar, tube, pipe, rope, winding, spiral or chain is used. During the formation of the double-bond-representation (FIG. 19, 21) between two atomic-representations two radical-neutral-connecting-elements of one atomic-representation are connected to two radical-neutral-connecting-elements of another atomic-representation, at which the radical-neutral-connecting-elements can be bend to each other, for connecting them then, because of the flexible middle section. Via this bending towards each other the binding-distance of the represented double-bond is shortened true to scale in comparison to the representation of a single-bond. In the same way it is possible to represent a triple-bond (FIG. 20, 22), in a way that again two radical-neutral-connecting-elements are bend to each other and are then connected to each other via a flexible link. Because of this results another true to scale shortening of the triple-bond-representation in comparison to the double-bond-representation.

### Electron-Pair-Representations Electron-Representations

According to the invention the challenge is solved by a molecular-building-set, which comprises atomic-representations with bound electron-representations and basic-atomic-bodies as well as detachable electron-representations. With it three different attraction-forces, bindings, respectively interactions, namely covalent bonds, plus-charge- and minus-charge-conjunction and electron-pair-attraction by basic-atomic-bodies are solved by three different connecting-systems. Covalent bonds are represented by radical-neutral-connecting-elements.

Conjunction of plus-charges and minus-charges are demonstrated by minus-charge-connecting-elements and plus-charge-connecting-elements. Interactions of atomic-cores with electron-pairs are represented by electron-pair-connecting-elements and basic-atomic-connecting-elements. A free electron is represented by an electron-representation, that consists of a minus-charge-connecting-element connected to a radical-neutral-connecting-element. A free electron represented by a combination of a minus-charge-connecting-element and a radical-neutral-connecting-element is thus a part of the molecular-building-set according to the invention. The electron-representation (this means the representation of a free electron) can on the one hand via the minus-charge-connecting-element be connected to a basic-atomic-body and on the other hand via the radical-neutral-connecting-element be connected with a second electron-representation to the representation of a covalent chemical bond.

### Radical-Neutral-Plug

Free radicals and free electron-pairs are represented by radical-neutral-connecting-elements like e.g. radical-neutral-plugs and covalent bonds are represented by the connection of two radical-neutral-connecting-elements like e.g. two radical-neutral-plugs that are connected to each other. The radical-neutral-connecting-elements are in that respect special, that each radical-neutral-connecting-element can be connected to each other radical-neutral-connecting-element. Technically in the preferred embodiment such connections are e.g. realized by radical-neutral-plugs, at which each radical-neutral-plug is shaped in such a way, that it can be connected to each other radical-neutral-plug. Preferred as radical-neutral-plugs are interlocking pins or something. For the creation of a connection of two radical-neutral-plugs respectively radical-neutral-connecting-elements no other connecting piece is needed.

### Charge Disjunction

Charge-disjunctions of plus- and minus-charges respectively charge-conjunctions are represented by plus-charge-connecting-elements and minus-charge-connecting-elements, at which these connecting elements lead to a male/female-connection, that means only one plus-charge-connecting-element can be connected to one minus-charge-connecting-element, but two plus-charge-connecting-elements or two minus-charge-connecting-elements cannot be connected to each other.

### Electron-Representations Always Identical

Decisive for the representation of reaction-mechanisms is, that detachable electron-representations with radical-neutral-connecting-elements and minus-charge-connecting-elements exist, that are recognizable as one unit. All detachable electron-representations of the molecular-building-set are in the preferred embodiment universally identical and universally elsewhere in the molecular-building-set again usable. Via disjunction of a minus-charge-connecting-element and a plus-charge-connecting-element a recognizable plus-charge and recognizable minus-charge is formed.

### Representation of the Whole Electron-Shell

According to the invention each electron of an atom, that is available for a chemical and preferably covalent bond is represented by a radical-neutral-connecting-element. All free electron-representations of an atomic-representation are represented with their connecting-elements at the basic-atomic-bodies of each single atomic-representation. Because of this each electron-representation and electron-pair-representation can be unmistakably allocated to one basic-atomic-body and single atomic-representations are recognizable as unit and building-block. Each atomic-representation thus carries all electron-representations with their connecting-elements for representation of all electronic-interactions and the basic-atomic-body carries all connecting-elements for representation of interactions of atomic-cores.

### 3.0 BASIC-ATOMIC-BODIES

To be able to represent molecules with the molecular-building-set according to the invention as close to reality as possible, as a starting point always an atomic-core representing basic-atomic-body is chosen, comprising protons and neutrons and non-binding electrons of the inner electron shell respectively chemically non relevant electrons of metals. The basic form of such a basic-atomic-body can be e.g. a ball, tetrahedron or another polyhedron. At the surface of these bodies are radical-neutral-connecting-elements (chap. 4.0) which in the preferred embodiment are represented by radical-neutral-plugs by pins and which are preferably tetrahedraly shaped fixed to the basic-atomic-bodies via flexible elements, which represent the electrons that are enabled for binding. As well in the preferred embodiment plus-charge-connecting-elements are represented at the surface (chap. 5.0), at which in the neutral basic-state of the respective elements electron representations are attached with their minus-charge-connecting-elements (chap. 5.0). As well in the preferred embodiment electron-pair-representations are connected to the surface of the basic-atomic-bodies of some of the non-metal-atomic-representations (chap. 6.0), which represent free electron-pairs.

These electron-pair-representations can in some cases be enabled to form two bond-representations of covalent-bonds and/or be enabled via the electron-pair-connecting-elements to connect to basic-body-connecting-elements and/or be enabled to flap out the electron-pair-representation under charge-disjunction and subsequent formation of a new binding-representation on another plus-charge connecting-element (FIG. 30). In the same way in the preferred embodiment at the surface of some of the basic-atomic-bodies of metal-atomic-representations basic-atomic-body-connecting-elements (chap 7.0) are represented (FIGS. 38-40), which serve for the connection to the electron-pair-representations of non-metal-atomic-representations (FIG. 23, 24).

At the basic-atomic-bodies of the atomic-representations of the first period (FIG. 41 (H and He)) in the preferred embodiment there are to the maximum only two positions at which connecting-elements are connected.

This corresponds to the reality in orbital-physics of these elements and is represented for the first time in the molecular-building-set accordingly to the invention. At the helium-representation there is only at one side one electron-pair-representation and at the hydrogen-representation, at one side of the basic-atomic-body there is a plus-charge-connecting-element at which an electron-representation binds in the neutral state and on the other side there is a basic-atomic-connecting-element which is permanently connected.

At the atomic-representations of the elements of higher periods e.g. 2., 3., 4., 5., period, the connecting-elements in the preferred embodiment are distributed onto the tetrahedral positions at the surface of the basic-atomic-bodies or if necessary onto the positions of the corners of a tetragonal bi-pyramid.

The elements can thereby be plus-charge-connecting-elements with thereon belonging electron representations, radical-neutral-connecting-elements, basic-atomic-body-connecting-elements or electron-pair-representations. One position of a basic-atomic-body can possibly as well stay free and not carry an element.

The basic-atomic-bodies preferably do have a color-code for the basic-atomic-bodies, at which always one color can be allocated to certain elements or element-groups.

The basic-atomic-bodies, that are died with the corresponding color, can be made of wood, metal, ceramic, glass, cardboard or plastic, preferably of plastic, and can have different three-dimensional basic-forms.

### 4.0 REPRESENTATION COVALENT BOND BY ELECTRON-REPRESENTATIONS

To be able to represent the different kinds of bindings that appear in the world of chemistry as exactly as possible, the above described concept of electron-representations, which is decisive for the patent, has been introduced. With the molecular-building-set according to the invention it is possible to represent different kinds of bindings of atoms close to reality. A covalent bond is represented in the present molecular-building-set by mutual connecting of two firmly connected electron-representations via their radical-neutral-connecting-elements (FIG. 3, 16-18).

Double- or triple-bonds can be represented by mutual connection of pairs or triplets of firmly connected electron-representations via their radical-neutral-connecting-elements (FIG. 19-22). Therein beginning with two identical or different basic-atomic-bodies two (in the case of double-bonds) or three (in case of triple-bonds) firmly connected electron-representations are connected with each other.

Hereby the flexible binding-tubes are a little bit bend and as a consequence the binding length of the represented double- and triple-bond, which is in the case of representations of multiple bonds the distance between the centers of the basic-atomic-bodies, are automatically shortened and thus a true to scale representation of the binding-lengths is reached. Respectively e.g. at the representation of the simple organic molecule Ethene (Ethylene) the four hydrogen-representations are automatically arranged in a plane. At the representation of the molecule Ethine (Acetylene) both hydrogen-atomic-representations are sterical in that way positioned, that they are arranged in a linear alignment for the representation of the triple-bond. Thus it is possible to represent in a clear way sp-, sp²- and sp³-hybridised bonds, it is as well possible between non carbon atoms.

The length of the flexible binding-tubes is in all cases chosen in that way, that always the true to scale bond-length is represented. The length of the flexible binding tubes is chosen in that way that always the true to scale binding-length is represented.

This means, it can be e.g. shown, that the representation of a carbon-nitrogen-bond or a carbon-oxygen-bond is shorter than a carbon-carbon-bond (like e.g. in FIG. 16-18 represented). It can e.g. as well be shown, that the representation of a nitrogen-carbon-double-bond is true to scale shorter, as a the one of a carbon-carbon-double-bond (like e.g. in FIG. 19-22 represented). Therein each firmly to a basic atomic body connected electron-representation consisting of a binding-tube and a neutral-radical-connecting-element has a certain length. Like this e.g., if the basic-atomic-bodies of carbon and nitrogen have the same size, a firmly connected electron-representation of carbon has a different length than a firmly connected electron representation of nitrogen. Thus it is guaranteed, that differently long bonds e.g. a carbon-carbon-bond or a carbon-nitrogen-bond are true to scale represented in their length. Therein the length of the effective binding distance (like e.g. in FIG. 16-18 represented) is the additive length of both effective-proportionate binding-distances. Therein the distance of the radical-neutral-connecting-elements form the center of the basic-atomic-bodies of the preferred embodiment is chosen in such a way, that they correspond true to scale to the effective proportionate binding-distances of the respective atomic-representations e.g.

| | | |
|---|---|---|
| H | 2.0 cm | 32 pm |
| C | 4.8 cm | 77 pm |
| N | 4.4 cm | 70 pm |
| O | 4.0 cm | 64 pm |

The effective true to scale distances of the radical-neutral-connecting-elements can as well be obtained if the basic-atomic-bodies of the different elements do have different sizes; the firmly connected electron-representations then need to have the respective true to scale length.

The length of the effective binding-distances thus are an indication of the electro-negativity of the corresponding element. The shorter the effective, binding-distances the more electronegative is the element.

In the preferred embodiment of the molecular-building set at the representation of double- and triple-bonds between two carbon atomic-representations, like as well between carbon-atomic-representations and non-carbon-atomic-representations via bending of the represented double-bond and even further bending of the triple bond a shortening of the distance between both basic-atomic-body-centers in comparison to a representation of a single-bond is created.

In interplay with the differently long binding-portions shortened distances are gained between the atomic-representations at the representations of multiple-bonds that are true to scale to the length of real chemical multiple-bonds (like e.g. in FIG. 19-22 represented). The representation of single binding-electrons by radical-neutral-connecting-elements is decisive for the invention.

Like herein used the term “radical-neutral-connecting-element” describes a connecting-element, which does not consist of two different connecting-elements like e.g. a female and a male connecting-element, at which only a male connecting-element can be connected to a female connecting-element and the connection of two male connecting-elements or two female-connecting elements is not possible like it is e.g. the case with a socket for a power-connection. The radical-neutral-connecting-elements like in the invention of different atomic-representations can all be mutually be connected to each other. Because through combination of two binding-electrons of two different atoms a covalent bond is formed, such a bond is represented by mutual connection of two arbitrary radical-neutral-connecting-elements of two different atomic-representations.

This means that radical-neutral-connecting-elements of each atomic-representation can be connected to all radical-neutral-connecting-elements of any other atomic-representation. According to the invention thus a representation of a covalent bond is obtained by mutual connecting of two radical-neutral-connecting-elements (like e.g. FIG. 16-18 in the preferred embodiment represented with radical-neutral-plugs).

This is a big advantage of the molecular-building-set according to the invention, because the number of the radical-neutral-connecting-elements per atomic-representation symbolizes the number of outer electrons and the user thus can on the basis of the number of radical-neutral-connecting-elements determine the maximum number of covalent chemical bonds, that the particular represented atom can build.

### 4.1 TECHNICAL EXECUTION RADICAL-NEUTRAL-CONNECTING-ELEMENTS

For radical-neutral-connecting-elements it is preferred, that the radical-neutral-connecting-elements are not directly firmly connected to the faces of the basic-atomic-bodies, but are sitting at the end of a flexible connecting link e.g. a tube, pipe or pin and the preferable flexible tube, pipe or pin ends in the center of a side-face of an atomic-basic-body and forms together with the radical-neutral-connecting-element a firmly connected electron representation.

Such a connecting link consists preferably out of flexible plastic or rubber. In the preferred embodiment the radical-neutral-connecting-element is preferably a radical-neutral-plug, that comprising its pins preferably consists of plastic, or hard-rubber, possibly of wood, cardboard, metal or other materials. Are two identical atoms connected to each other, like e.g. two carbon-atomic-representations then the radical-neutral-plug-connection lies preferably in the middle between the basic-atomic-body-centers.

### Radical-Neutral-Connecting-Elements in General

Charge disjunction of plus- and minus-charges respectively charge-conjunctions are represented by a special kind of plus-charge-connecting-elements and Minus-charge-connecting-elements, which correspond to a male/female connecting-principle. Ionic-bonds, coordination-bonds and hydrogen-bonds are represented by basic-atomic-connecting-elements and electron-pair-connecting-elements, that correspond to a thereto different male/female-connecting-principle. At a male/female-connecting-principle a bond can only be formed by a female-connecting-element to a male-connecting-element, but not by two male-connecting elements or two female-connecting-elements. Decisive for the invention is that the three in this paragraph named binding- and force-types are represented by three different connecting-principles, so that these three binding-types can be distinguished by the spectator.

The above represented variant to represent bindings with help of flexible tubes and radical-neutral-plugs is preferred.

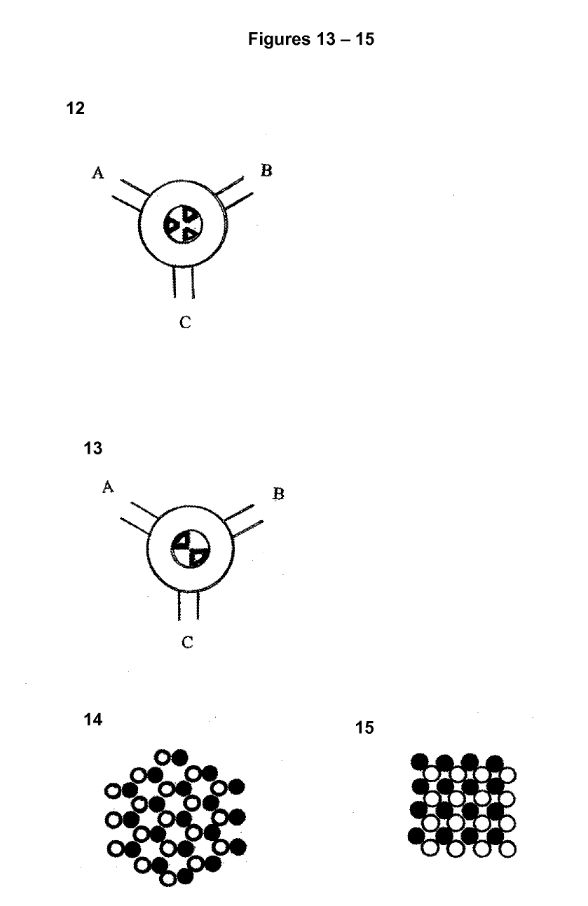

Another possibility to represent covalent bonds between two atoms instead of pins and recesses or block-outs for the pins of the plugging radical-neutral-plug can e.g. happen by magnets with north- and south-pole, hook and loop-fasteners with hooks and loops on each of both plugs or the gecko-adherence-principle with faces and small suction-cups on each of both plugs or other plus-minus-adherence- and plug-principals that are arranged in patterns. In this embodiment the for the representation of a binding responsible contact-surface is equipped with patterns of alternating north- and south-poles respectively male- and female-positions, in a way that furthermore each plug of this kind can be combined with each other plug of this kind. The pattern of the arrangement of the male and female positions are again in accordance to the patterns that are sensible for radical-neutral-plugs. This means a radical-neutral-connecting-element carries on the connection face that is preferably a circular disc no pins but these are substituted by magnetic elements or elements of another male/female-connecting-principle, at which on each face the male as well as the female elements are present. Thus plugs are generated, that are furthermore neutral, because each plug, has either male elements as well as female elements, which respectively interact with the female as well as the male elements of the other plug to form a binding. The geometry of the male- and female-positions at the contact face can be again annularly arranged like the pins in FIG. 1, 2, 3, 6, 8 and FIGS. 12 and 13 or be distributed on the contact face like in the patterns in FIGS. 14 and 15. The number of male- and female-positions on the available contact face can vary. Preferable is a total number or 1, 2, 3, 4, 5, 6, 7, 8, 9, 10, 11, 12, 13, 14, 15, 16, 17, 18, 19, 20 or more male- and female-positions thinkable.

### Arrangement Patterns for Radical-Neutral-Connecting-Elements

The pins of a radical-neutral-plug can besides the preferred annular execution as well be arranged in that way on the disc that the pins of one side of the plug are on the positions of black squares of a chess-board-pattern and the recesses are on the white squares of such a chess-board-pattern (FIG. 15). Respectively the pins of the opposite radical-neutral-plug which has an identical configuration be shifted into the recesses of the first radical-neutral-plug. Because of this construction these radical-neutral-plugs do not meet in the middle of the connecting-axis which by plugging together, are shifted by about half of the diameter of a pin out of the middle of the connecting-axis. At such an arrangement the pins are preferably either round or have a square basic shape.

Besides the pattern of FIG. 15 further patterns are possible that derive from adding or leaving out single or multiple pins from the patterns of FIG. 15.

Another possible arrangement for the pins of the radical-neutral-plug are equilateral triangles as basic-pattern for the positions of the pins, at which each pin is involved in up to six triangles and an interrelated pattern of equilateral triangles is generated (FIG. 14). Because of this it is possible to receive six positions that are twisted by around 60°. Because of the shift out of the middle of the binding axis the angles do not precisely correspond to staggered an d eclipsed but only approximately. At plugging together of two radical-neutral-plugs multiple possible positions are offered for plugging together for the identically constructed opposite radical-neutral-plugs. The always other possible plugging position stays empty. Because of this construction these radical-neutral-plugs do not meet in the middle of the connecting-axis while plugging together, but are shifted by about half of the diameter of a pin out of the middle of the connecting-axis. At such an arrangement the pins are preferably either round or have six lateral faces of a equilateral hexagon.

Besides the pattern of FIG. 14 further patterns are possible that derive from adding or leaving out single or multiple pins from the patterns of FIG. 14.

At the in FIGS. 14 and 15 described radical-neutral-plug-geometry 3 until 40 or more pins are used. Preferably 4 until 18 pins are used.

The choice of the right pattern of the pins of the radical-neutral-plugs or generally of the connecting-principles at radical-neutral-connecting-elements makes it possible, that all radical-neutral-plugs or generally phrased all radical-neutral-connecting-elements are at any time combinable with each other.

Because in the chemical literature often representations are used, at which in molecules two neighbored carbon atoms are either staggered or eclipsed represented, is besides of the mutual combinability of two radical-neutral-plug respectively radical-neutral-connecting-elements as well desired, that under mutual connecting to a representation of a covalent bond exactly these angles can be set, that correspond to a staggered or eclipsed conformation.

### Rotatability of the Radical-Neutral-Connecting-Elements

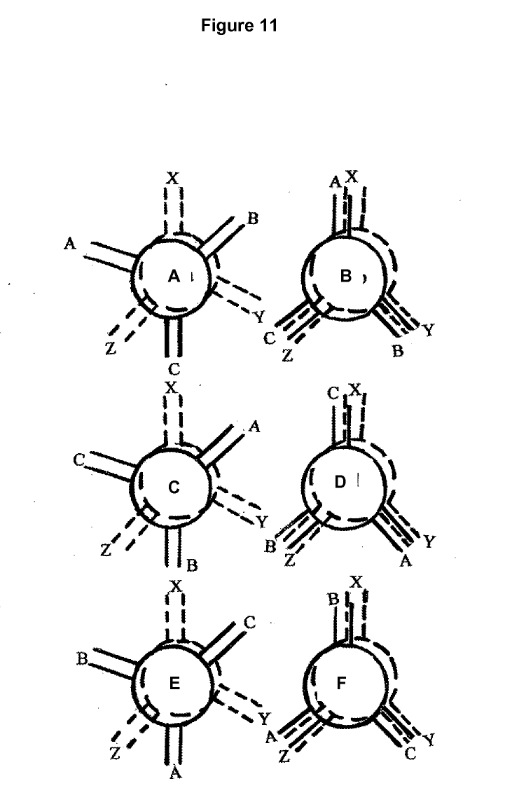

Thus it is preferred that radical-neutral-plugs have a rotatable head, so that the The atomic-representations independent of the used pattern of the pins can be rotated around the binding-axis in this way, that each desired different conformation can be represented like e.g. the staggered- and eclipsed-conformation (FIG. 11).

More generally viewed it is preferred, that the radical-neutral-connecting-elements have a rotatable head, so that the atomic-representations can independently of the used pattern, with which the used connecting-principles are positioned on the radical-neutral-connecting-element be rotated, in a way that different desired conformations can be represented like e.g. the staggered- and eclipsed-conformation (FIG. 11).

To get in an especially preferred embodiment of the molecular-building-set with rotatable and in click-in place-positions lockable electron-representations for the precise representation of staggered and eclipsed-conformation, an annularly constructed C₃ₙ-radical-neutral-connecting-element which in certain positions clicks in place does exist. The click-in place-positions of this preferred embodiment do have at any time the same C₃ₙ-rotational-symmetry like the corresponding C₃ₙ-radical-neutral-connecting-element.

### C₃ₙ-Radical-Neutral-Connecting-Elements

In a preferred embodiment a radical-neutral-connecting-element is represented with a C₃ₙ-rotational-symmetry, with n from 1 until 20, preferred from 1 until 4 and each C₃ₙ-radical-neutral-connecting-element of this type can be connected with each C₃ₙ-radical-neutral-connecting-element of the same type. Only because of the C₃ₙ-radical-neutral-connecting-elements with C₃ₙ-rotational-symmetry all three different staggered or all three different eclipsed positions can be obtained. According to the invention these radical-neutral-connecting-elements do have a C₃ₙ-rotational-symmetry, this means with a three-numbered, six-numbered, nine-numbered etc. rotational-axis. Especially preferred is the embodiment with n=2 and thus a C₆-radical-neutral-connecting-element, at which each C₆-radical-neutral-plug of this type can be connected with every C₆-radical-neutral-plug of the same type. At which all six different staggered and eclipsed positions, that result from the tetrahedral shape are representable.

### Radical-Neutral-Plug

Preferred are in the molecular-building-set according to the invention as radical-neutral connecting elements radical-neutral-plugs (as they are used e.g. in FIG. 1, 2, 3, 6, 8, 12, 13 represented in the preferred annular embodiment).

In a preferred embodiment of a radical-neutral-plug every radical-neutral-plug consists of multiple pins, which are arranged on a disc (like e.g. in the embodiments of the FIGS. 1, 2, 3, 6, 8, 12, 13, 14, 15 is represented) and between the pins are recesses, which have about the same volume like the pins and are able to take in the pins of a further radical-neutral-plug. Every radical-neutral-plug has preferably a compartmentation in shape of pins and recesses which has one pin, two pins, three pins, four pins, five pins, six pins, seven pins, eight pins, nine pins, ten pins, eleven pins, twelve pins, thirteen pins, fourteen pins, fifteen pins, sixteen pins, seventeen pins or eighteen pins or a higher number of pins. Especially preferred are three, six, nine, twelve, pins or a number of pins that is a multiple of three.

Furthermore the pins are preferably annularly arranged on a circular disc. As a result follows, that the pins are preferably tapering to the center of the circular disc respectively to the binding axis (e.g. in the preferred embodiment with six pins in the FIG. 1, 2, 3, 6, 8 represented). The pins are preferably positioned vertically on the circular disc and are symmetrically arranged. Between the pins are recesses of the same size, which correspond in shape and volume to the pins, because these recesses serve for the intake of the pins of the second radical-neutral-plug. The circular disc with the pins sits on the end of a spacer which is formed as a bar, tube, cylinder or something like it, at which the circular disc can preferably rotate around the longitudinal axis of the spacer that means of the bar, of the tube, of the cylinder or something like it.

Especially preferred is a number of 3, 6 and multiple of 3 pins and corresponding with it 3, 6 or a multiple or three recesses for the intake or 3, 6 or a multiple of three pins of another radical-neutral-plug with a C₃ₙ-rotational-symmetry. This preferred embodiment is shown in (FIG. 1, 2, 3, 6, 8). It is recognizable, that on the end of a tube, or pipe is a radical-neutral-plug with a six-fold compartmentation this means with six pins. FIGS. 1 and 6 show the preferred radical-neutral-plug from the top and the recesses and as well as the tapering pins are recognizable. FIGS. 3 and 16-18, represent a covalent bond of two radical-neutral-plugs.

The C₃ₙ-radical-neutral-plug shows therefore in the preferred embodiment a compartmentation in shape of pins and recesses, in which the pins of the second C₃ₙ-radical-neutral-plug can interlock, at which the radical-neutral-plug preferably has more than one and less than 30 pins, further preferred more than 2 and less than 20 pins and especially preferred 3, 6, 9 or 12 pins, which can interlock into the corresponding recesses of the second C₃ₙ-radical-neutral-plug, to form the covalent bond.

Especially preferred are 6 pins, because of that 6 configurations of the two C₆-radical-neutral-plugs that are twisted by 60° toward each other are obtained and because of this molecules ban be build with realistic angles, what is beneficial e.g. at eclipsed, staggered conformations, boat- and chair-configuration of six-rings, at sugar-molecules and at double- and triple-bonds (lock as well at e.g. FIG. 11)

A covalent bond in the preferred embodiment is thus represented by two interlocking plugs, at which the two radical-neutral-plugs are compartmented by the same number of pins on the ring of pins. Because of this radical-neutral-plugs are obtained, which can be twisted around the binding-axis of the covalent-bond, and are in an extreme embodiment freely rotatable or in arbitrarily fine steps by relocation of the plugs can be rotated against each other (which means in steps of 360° divided by the number of pins per radical-neutral-plug). A radical-neutral-plug-connection with tree pins per radical-neutral-plug can therefore take three positions that are twisted by 120° against each other, whereas a radical-neutral-plug-connection with 12 pins per radical-neutral-plug can take 12 positions that are twisted by 30° against each other.

### Chiral Construction of the Radical-Neutral-Connecting-Elements

In an especially preferred embodiment of the molecular-construction-set with non freely rotatable and firmly connected or with rotatable and in click-in-positions stoppable electron-representations to obtain the precise representation of staggered and eclipsed confirmations, an annularly build C₃ₙ-radical-neutral-plug respectively in general an annularly constructed C₃ₙ-radical-neutral-connecting-element is necessary, which is twisted by half of the angle of a position of a pin firmly connected or stoppable in a click-in position, do exist.

The click-in-positions of this preferred embodiment do have the same C₃ₙ-rotational-symmetry like the corresponding C₃ₙ-radical-neutral-connecting-element. In such a preferred embodiment with an annular arrangement of 3,6 pins or a multiple of three pins of the C₃ₙ-radical-neutral-plug, the C₃ₙ-radical-neutral-plugs are in such a way fixed to the basic-atomic-bodies, that not the middles of three of the six pins or at a multiples of three, always three, are directed towards the three other tetrahedral positions (FIG. 12,9,10) but the level of side-faces of each of the three pins of a radical-neutral-plug are in the same level with the middle of the three other tetrahedral positions. That means that at a six pin version with a firmly connected radical-neutral-plugs, the plug is twisted by half of 360° divided by 12, that means twisted a 24^{th} of 360°, that means 15° in one direction.

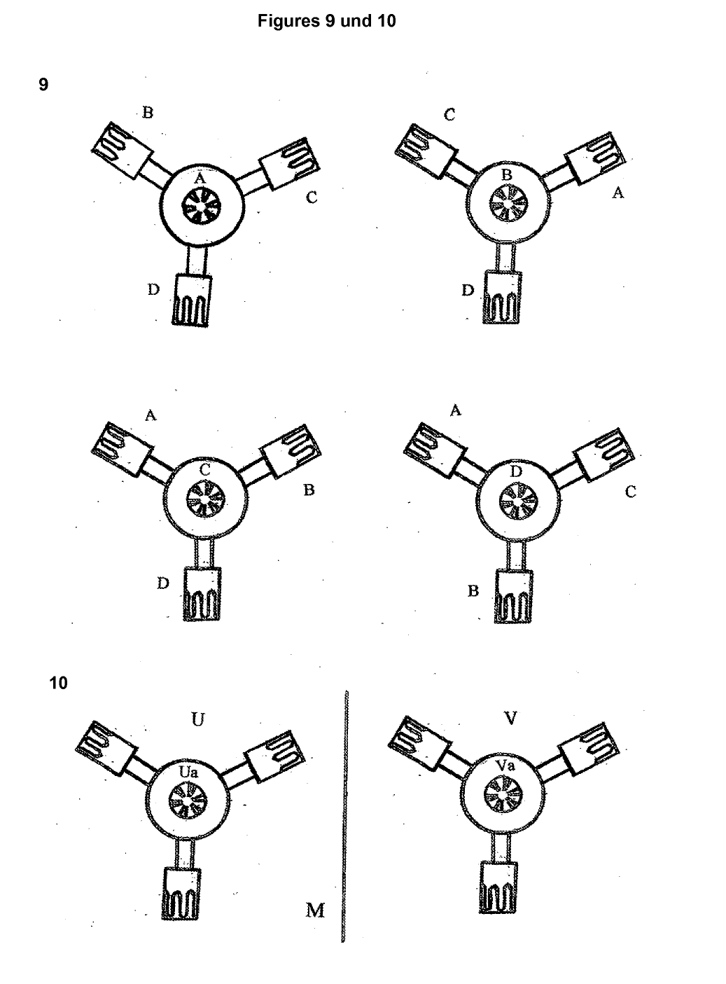

Because of this the firmly connected radical-neutral-plugs are chiral. As a result of this the whole in FIG. 9 represented carbon-atomic-representation is as well chiral. That means (FIG. 10) that it is not possible to transform, to in that way positioned radical-neutral-plugs Ua and Va by mirroring on mirror-axis M into each other. Comparable with two right hands which can be transformed into each other via shifting over each other but not via mirroring. This is decisive for obtaining exact representations of staggered- and eclipsed-conformations because by an annular construction it is only possible to obtain the in FIG. 10 represented staggered and eclipsed conformations in a precise way, with help of this chiral construction. Therein it is important that all used plugs must be twisted into the same direction by the corresponding angle. In comparison to chemical molecules spoken: all must be dextro-rotatory or leavo-rotatory. With non-chiral annular plugs at plugging together an eclipsed-conformation would never be possible, but always a not desired angle-shift would occur, at which the precise staggered- and eclipsed-conformations would not be obtainable. In the same way the in (FIG. 12) represented basic-atomic-body-fragments with radical-neutral-plugs with three pins in the preferred embodiment are chiral. Because at a version with three pins, the plug must be twisted by the half of 360° divided by 6, that means a 12^{th} of 360°, which means 30° in one direction. Generally the same applies as well to C₃ₙ-radical-neutral-connecting-elements in firmly connected electron-representations at which different adhesion or connecting principles are applied. Staggered- and eclipsed-conformations can be obtained by building the C₃ₙ-radical-neutral-connecting-element correspondingly annularly and chiral.

For example a C₃ₙ-radical-neutral-connecting element of a preferred embodiment could carry annularly arranged alternating six south-poles and six north-poles. These as well should correspond to the construction of the C₃ₙ-radical-neutral-plug with six pins and recesses and be twisted by 15° in on direction around the binding-axis and thus be chiral, for obtaining staggered- and eclipsed-conformations.

According to the invention in the preferred embodiment, the rotatory-degrees-of-freedom of the radical-neutral-connecting-elements and the minus-charge-connecting-elements of both sides of a detachable electron-representation are preferably related to each other independent of the construction of the radical-neutral-connecting-element. Is for example a radical-neutral-connecting-element with sixfold compartmentation chosen, which therefore possesses a C₆-rotational-symmetry a pin can be chosen for the electron-representation, which possesses a hexagonal shape with C₆-rotational-symmetry which can then be inserted in a corresponding hexagonal plus-charge-recess of the basic-atomic-bodies. Another possibility besides of the preferred embodiment to represent a radical-neutral-connecting-element is a bayonet-lock like in water-tube-couplings. Therein it is thinkable, that such a bayonet-lock possesses different numbers of interlocking rails or convexities. Preferred is a total number of 1 till 12 or more rails or convexities. Another possibility besides of the preferred embodiments to represent a radical-neutral-connecting-element is a hook-and-loop-fastener with hooks and loops on each of both sides of the opposite adherence-faces respectively all contact-faces of the radical-neutral-connecting-element.

### 4.2 FREE RADICALS

Molecular-representations, atomic-representations or ionic-representations, at which not all radical-neutral-connecting-elements are connected with other radical-neutral-connecting-elements and these are therefore recognizable as unconnected radical-neutral-connecting-elements, that represent free radicals. E.g. FIGS. 31 and 32 hydrogen-radical or FIG. 41 (Cl) Chlorine-radical. If in addition to the unconnected radical-neutral-connecting-element another plus-charge-connecting-element is recognizable on the basic-atomic-body or on one of the basic-atomic-bodies of molecules, this is a representation of radical-cations and if a minus-charge-connecting-element is recognizable besides one radical-neutral-connecting-element, this represents a radical-anion. In the molecular-building-set according to the invention it is possible for the first time to represent radicals, radical-anions and as well radical-cations. And for the first time it is possible to represent these radicals with the precise positions in molecular-representations and respectively as well in combination with charges. Therefore it is possible for the first time to play through radical-reaction mechanisms, with which it is possible to recognize the relocation of each single electron, radical and electron-pair in the right order an spacial dimension.

### 5.0 CHARGE-DISJUNCTION, CHARGE-CONJUNCTION, ANIONS, CATIONS, DETACHABLE ELECTRONS

Detachable electron-representations consist in a preferred embodiment out of one part of a flexible element, which possesses on one end a minus-charge-connecting-element for connecting to the plus-charge-connecting-element of the basic-atomic-body and on the other end a radical-neutral-connecting-element.

A minus-charge-connecting-element is represented in the preferred embodiment as minus-charge-plug, as a pin and symbolizes a negative charge. The plus-charge-connecting-elements, which are represented in the preferred embodiment as plus-charge-recesses (holes) in the basic-atomic-body, represent a positive charge.

The plus-charge-connecting-elements have in the preferred embodiment the same rotational symmetry like the minus-charge-connecting-elements and a negatively shaped fit (e.g. in FIG. 6, 7, 8, 37-40 represented). Therein the symmetry of the minus-charge-connecting-element in the preferred embodiment is chosen that way that it has the same rotational-symmetry like the radical-neutral-connecting-element which preferably possesses a C₆-rotational-symmetry.

The minus-charge-connecting-elements in the preferred embodiment always show the same color, which in the preferred embodiment is black. The plus-charge-connecting-elements preferably show always one color, which in the preferred embodiment is red. So that the spectator is able to recognize the charge as a color code. While mutually connected, both colors are getting covered form the spectator and the mutually connected charge-connecting-elements are represented as being neutral. Is a connection of a minus-charge-connecting-element and a plus-charge-connecting-element disconnected, inevitably charged ionic-fragments are generated. Is in contrast the connection of two radical-neutral-connecting-elements disconnected, two radical fragments are generated. The preferred embodiment of the minus-charge-connecting-elements is a minus-charge-plug and consists of one or several pins which consist of plastic, ceramic, glass, wood, metal or other material and is connected to the flexible element of the electron representation. The pins preferably have a geometry which is a rotational-symmetry, which is a multiple of three. Especially preferred is the embodiment with a C₆-rotational-symmetry. Besides of the preferred embodiment it is as well possible that a minus-charge-plug is represented by a recess on the electron-representation and the plus-charge-plug is represented by a thereto corresponding pin on the basic-atomic-body. Besides the preferred embodiment as plus-charge-plugs and minus-charge-plugs any other possible male or female plugging, adherence or connecting-systems are applicable, like e.g. north-pole and south-pole of magnets, hook-and-loop-fasteners with hooks on side and loops on the other side of the hook and loop fastener, or a gecko-adherence-principle.

The detachable electron-representations are preferably only on the atomic-representations of elements, which can chemically seen form cations by the donation of electrons. Thereby on the basic-atomic-bodies, there are preferably only as many plus-charge-connecting-elements as many plus-charges the corresponding chemical-element in a chemical reaction can show. The above mentioned plus-charge- and minus-charge-connecting-elements are according to the invention as well used for representation of ionic compounds like e.g. Na⁺Cl⁻ or CF₃COO⁻ NH₄⁺. The atomic-representations of the molecular-building set according to the invention are preferably always neutrally charged, if all electrons are connected to the basic form.

### 6.0 REPRESENTATION OF FREE ELECTRON-PAIRS

Another specific feature of the molecular-building-set according to the invention is the representation of free electron-pairs of electron-pair-representations (like e.g. in FIG. 23-30, 36 represented in the preferred embodiment). See as well chap 1.1 term definitions of electron-pair-representations. Electron-pair-representations are represented as connection of two electron-representations, which are detachably connected to the basic-atomic-body or which are permanently connected. In the general embodiment the detachable electron-pair-representations have radical-neutral-connecting-elements and minus-charge-connecting-elements. With the molecular-building-set according to the invention it is now for the first time possible, to represent free electron-pairs and their reactions in an illustrative way. So called free electron-pairs are a different kind of electrons which surely can form bonds but are not belonging to the reactive unpaired outer electrons. Free electron-pairs are completely belonging to one atom but can as well participate in different kinds of reaction-types:
Formation of inter-molecular forces like for instance hydrogen-bridges (like e.g. represented in FIG. 36) complex-bindings and ionic-bonds.
Formation of double-bonds e.g. to oxygen-atoms or two single-bonds to two flourine-atoms.
Disconnection of an electron-pair-representations by charge-disjunction e.g. in the hydroxonium-ion or the nitrate-ion

In the preferred embodiment the electron-pair-representations are able to form at minimum three different forms of binding representations, double-binding-representations, two single-binding-representations, coordination-binding-representations via a connection of electron-pair-connecting-elements on the basic-atomic-body-connecting-elements and single-binding-representations by charge-disjunction with a plus-charge-recess that remains, this means of one plus-charge-connecting-element on the basic-atomic-body-representation.

In the preferred embodiment all representations of binding-types which are able to form electron-pair-representations like in the preferred embodiment of the FIGS. 16-18 and 19-22 and 36 represented) are forming true to scale binding-lengths. Electron-pair-representations, which are not able to form a representation of a bond are represented by a closed electron-representation (like e.g. in the preferred embodiment in FIG. 24, 25 and in FIG. 41 Neon (Ne) represented). Depending on whether the free electron-pairs of the corresponding atoms can form hydrogen-bridges, complex-bindings, Lewis-acid-base-reactions or not, the electron-pair-representations of the preferred embodiment possess an electron pair-connecting-element or not.

### 6.1 REPRESENTATION OF INTER-MOLECULAR FORCES BY ELECTRON-PAIR-CONNECTING-ELEMENTS AND BASIC-ATOMIC-BODY-CONNECTING-ELEMENTS

Electron-pair-representations do have an electron-pair-connecting-element so that they can be connected to the basic-atomic-body-connecting-element of basic-atomic-bodies of hydrogen-atomic-representations and metal-atomic-representations. In the preferred embodiment this electron-pair-connecting-element is connected on the outside (like in e.g. in FIGS. 23 and 24 represented as a ball of a ball-coupling-plug shaped).

The connection of electron-pair-connecting-elements and basic-atomic-body-connecting-elements is based on a male/female connecting-principle.

In the preferred embodiment the electron-pair-connecting-element is represented by an electron-pair-coupling-plug and the basic-atomic-body-connecting-element is represented as basic-atomic-body-coupling-plug.

At which the electron-pair-coupling-plug in the preferred embodiment is shaped as ball of a ball-coupling and the corresponding basic-atomic-body-coupling-plug is shaped as ball-holder.

The connection of electron-pair-representations on basic-atomic-bodies is with any other possible male/female connecting-principles thinkable. These can be ether ball-couplings with ball and ball-holder, plugging-contacts with pins and recesses, magnets with north-pole and south-pole, hook-and-loop-fasteners with hooks and loops, gecko-adherences with suction-cups and faces or connecting-elements which are based on other male/female connecting principles (look at chap. 1.1 Definition electron-pair-connecting-elements).

In the preferred embodiment the pair of the electron-pair-connecting-element and the basic-atomic-body-connecting-element differs basically, although it is also a male/female connecting principle, from the pair of minus-charge-connecting-element and plus-charge-connecting-element, so that no chemical nonsense connection e.g. of a minus-charge-connecting-element on a basic-atomic-body-element or as well the other way around and no chemical nonsense connection of an electron-pair-connecting-element on a plus-charge-connecting-element is possible.

Different forces are represented by specifically different connecting-elements. Therefore in the preferred embodiment no connection of the four above mentioned connecting-elements to the radical-neutral-connecting-elements is allowed. In the preferred embodiment charge-disjunctions respectively charge-conjunction-connections of plus-charge-connecting-elements and minus-charge-connecting-elements have their own male/female connecting-principle, plugging-principle or adherence-principle. As well do electron-pair-connections on basic-atomic-bodies do have their own male/female-connecting-principle. Further radical-neutral-connecting-elements do have as well their own neutral-connecting-principle. In the preferred embodiment to each atomic-representation a set of connecting-elements can undoubtedly be related to and thus an atomic representation can be recognized as unit respectively as building-block.

In the preferred embodiment the connecting-elements are not added as foreign-elements like e.g. poles, pins, tubes or other elements, like it is the case in other molecular-building-sets. In molecular-building-sets of the state-of-the art balls and single tubes are usually stuck together to build molecules, in such a way that single atoms cannot be recognized as building-blocks.

In the preferred embodiment these electron-pair-connecting-elements fit to all basic-atomic-body-connecting-elements of all different basic-atomic-bodies. That means that e.g. the electron-pair-connecting-elements of oxygen-atomic-representations, chlorine-atomic-representations or nitrogen-atomic-representations all fit either to the basic-atomic-body-connecting-elements of the hydrogen-atomic-representations (FIG. 34-36) and therefore can form a representation of a hydrogen-bridge, or as well to the basic-atomic-body-connecting-elements of all metal-atomic-representations (FIG. 38-40) and therefore can represent complex-bindings, or as well to the basic atomic-body-connecting-elements of aluminum-atomic-representations, magnesium-atomic-representations or other metal-atomic-representations, for representing with it Lewis-acid-and-base-connections, or as well to the basic-atomic-body-connecting-elements of metal-atomic-representations for representing with it the grid-bindings in ionic-grids respectively ionic-bonds.

### 6.2 DISCONNECTION OF THE MUTUAL CONNECTION OF TWO RADICAL-NEUTRAL-CONNECTING-ELEMENTS WITHIN AN ELECTRON-PAIR-REPRESENTATION

In the preferred embodiment an electron-pair-representation is represented by two electron-representations like e.g. in the FIG. 23, 26-28 in the preferred embodiment with radical-neutral-plugs represented. The electron-representations are either both firmly connected to the basic-atomic-body or one of the electron representations can be removed from the basic-atomic-body by charge-disjunction, (like e.g. in FIG. 23, 26-30 represented). Only if the connection between both radical-neutral-connecting elements are disconnected the electron-pair-representations can form two representations of bindings (FIG. 28). Then both radical-neutral-connecting-elements can be connected to radical-neutral-connecting-elements of foreign atomic-representations. This way molecules like e.g. SO₃ can be represented, at which both electron-pair-representations of the sulfur-atomic-representation, each under forming of a double-binding-representation can form a representation of a covalent binding with an oxygen-atomic-representation.

### 6.3 CHARGE-DISJUNCTION BETWEEN ELECTRON-PAIR-REPRESENTATIONS

In the preferred embodiment of electron-pair-representations it is possible that the detachable electron-representation which is contained in the electron-pair-representation, is disconnected in its binding at the position of the minus-charge-connecting-elements and plus-charge-connecting-elements under charge-disjunction and not at the position of radical-neutral-connecting-elements (as described in chap. 6.2).

At the basic-atomic-body then remains an unconnected plus-charge-connecting-element, which symbolizes a positive charge. The minus-charge-connecting-element is then positioned on the other side of the flapped-out electron-pair-representation (like e.g. in FIG. 29 visible) in shape of a minus-charge-connecting-element and can be connected under charge-conjunction with a plus-charge-connecting-element (as e.g. in FIG. 30 represented). In the same way the representation of a hydroxonium-ion is possible, because here as well as e.g. in FIG. 36 shown a hydrogen-ionic-representation is connected under charge-conjunction to an electron-pair-representation which was opened under charge-disjunction (see also FIG. 41 (O) oxygen).

Thus it is possible to represent that the formerly free electron-pair-representation relocates to the representation of a covalent binding under charge-conjunction with the H+-ionic-representation (see also FIGS. 29, 30 and 33) and thus as a result a free plus-charge-connecting-element is positioned on the basic-atomic-body of the oxygen.

In the same way it is possible for the first time with help of these charge-disjunctions within electron-pair representations to represent with a molecular-building-set the binding relations within a nitrate-ion or similar compounds, which obtain the octet-rule by inner-molecular charge-disjunction.

A technically sensible solution within the preferred embodiment is that the radical-neutral-connecting element is firmly-connected to a pivoting-element (as in FIG. 23, 27-30 represented) and because of this in states they can point into different directions (look as well Chap. 7.4), so that the electron-pair-representations are mechanically able to perform the in chap. 6.2 and 6.3 described disconnections of the connecting-elements.

### 7.0 ELECTRON-PAIR-CONNECTING-ELEMENTS AND BASIC-ATOMIC-BODY-CONNECTING-ELEMENTS

In chemistry besides of the bindings of two atoms with each other, the binding of electron-pairs with basic-atomic-bodies is of central significance. In the molecular-building-set according to the invention these interactions between basic-atomic-bodies and free electron-pair-representations are for the first time illustratively represented. Based on these interactions the coordination-binding-positions of complexes, hydrogen-bridges, Lewis-acids-and-bases and ionic-bindings can be represented with one system of connecting-elements.

### 7.1 HYDROGEN-BRIDGE OF THE HYDROGEN-ATOM

A hydrogen-atomic-representation does have besides of the plus-charge-connecting-element a basic-atomic-body-connecting-element at the basic-atomic-body, at which it can be connected to electron-pair-representations and thus can represent a hydrogen-bridge (like e.g. in FIG. 36 represented in a preferred embodiment). In the preferred embodiment the basic-atomic-body connecting-element can be in two states. In one state the basic-atomic-body-connecting-element is configurated in that way, which an electron-pair-connecting-element can be connected to it (like e.g. represented in the preferred embodiments, which are represented in FIG. 34-36). This is the state that can be e.g. found in water-molecules. In the other state the basic-atomic-body-connecting-element is configurated in that way that an electron-pair-connecting-element can not be connected to it (like e.g. in the preferred embodiment that is represented in FIG. 31-33). This is the state that e.g. exists in representations of methane. The transformation between these two states can be based on very different technical solutions. In the preferred representation the basic-atomic-body-connecting-element is firmly connected to one or several pins, and this pin or the several pins again are connected to a pivoting-link to the basic-atomic-body and thus can be flapped towards the basic-atomic-body (like e.g. in FIG. 31-36 is represented). At this example with the preferred embodiment as basic-atomic-body-coupling-plug it is recognizable that the basic-atomic-body-connecting-element is only in the flapped out position able to connect to an electron-pair-connecting-element, because only in the flapped out state the ball of the electron-pair-coupling-plug can be plugged into the ball-coupling-holder of the basic-atomic-body-plug. In the flapped in state the hole is not accessible. Preferable is therein, that the basic-atomic-body-connecting-element is represented by a basic-atomic-body-coupling recess. Besides of the preferred embodiment the basic-atomic-body-connecting-element could as well be constructed in another way, like described in chap. 7.4, chap. 1.1 and chap. 6.1. Because of the representation of hydrogen-bridges with this molecular-building-set it is for the first time possible to illustratively explain the difference between lipophilic and hydrophilic.

### 7.2 COORDINATION-BINDING-POSITIONS OF COMPLEXES, LEWIS-ACID-AND-BASIS, IONIC-BINDINGS, BASIC-ATOMIC-BODY-CONNECTING-ELEMENTS AND METAL-ATOMIC-REPRESENTATIONS

The Ions of metals of higher shells can not only couple with one free electron-pair, but with several, usually with up to six. That way connections like e.g B(OH)₄⁻, Al(OH)₄⁻ or Al(OH)₆³⁻ can be formed. The formation of such bindings of the atomic-body at aluminum with complex-ligands like e.g. H₂O, Cl⁻ or OH⁻ is called Lewis-acid-base-reaction.

Metals of the d-Block (like e.g. iron or Fe) often form complexes with up to six ligands at which also the electron-pairs of ligands are connected to the metal-ion. In the molecular-building-set according to the invention such coordination-binding-positions can be for the first time illustrative represented, as basic-atomic-body-connecting-elements of complexes and bindings of Lewis-acids-and-bases as represented in the preferred embodiment with basic-atomic-body-coupling-recesses in different spacial dimensions (like e.g. in FIG. 37-40). Like described in the chapter basic-atomic-bodies, the basic-atomic-bodies of metal-atomic-representations are depending on the chemical element of different sizes and carry as many plus-charge-connecting-elements as is typical for the according chemical element.

It is decisive for the invention that all connections of free electron-pairs on the basic atomic body are formed by basic-atomic-body-connecting-elements including the hydrogen-bridge-representations with the identical connecting-, adherence- or plugging-principle, which can be besides the preferred ball-coupling connection also technically be solved differently (like in chap 7.4, chap 6.1 and chap 1.1 described).

IN the preferred embodiment the basic-atomic-bodies of each metal-atomic-representation have six basic-atomic-body connecting-elements (like e.g. in the FIG. 37-40 in the preferred embodiment with basic-atomic-body-coupling-recesses represented), which can show the most important geometries (like described later), which play a role in chemistry and these are shaped in metal-atomic-representations in the same way.

Basic-atomic-connecting-elements are preferably firmly connected to single or several pins. These pins, that carry basic-atomic-body-connecting-elements, are on the other end preferably firmly connected to a pivoting-link at the basic-atomic-body. The firm connection is shaped in such a way, that it is possible to represent with the six out-foldable basic-atomic-body-connecting elements the most important shapes of coordination: tetragonal-bipyramidal, tetrahedral, tetragonal-planar (like e.g. in FIG. 37-40 represented in the preferred embodiment with basic-atomic-body-coupling-recesses).

Technically the formation of the shapes of coordinations in the preferred embodiment is solved in such a way, that four of the tiltable basic-atomic-body-connecting-elements are on the equatorial circumference of the basic-atomic-body firmly connected, so that these in the fully out-folded state are pointing into all four directions of the equatorial level.

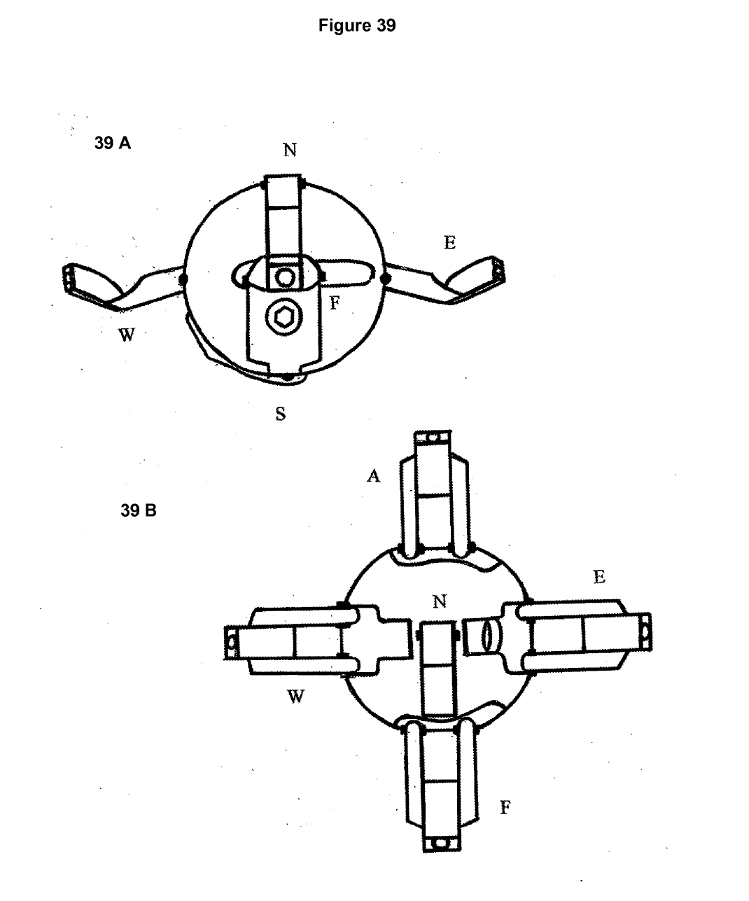

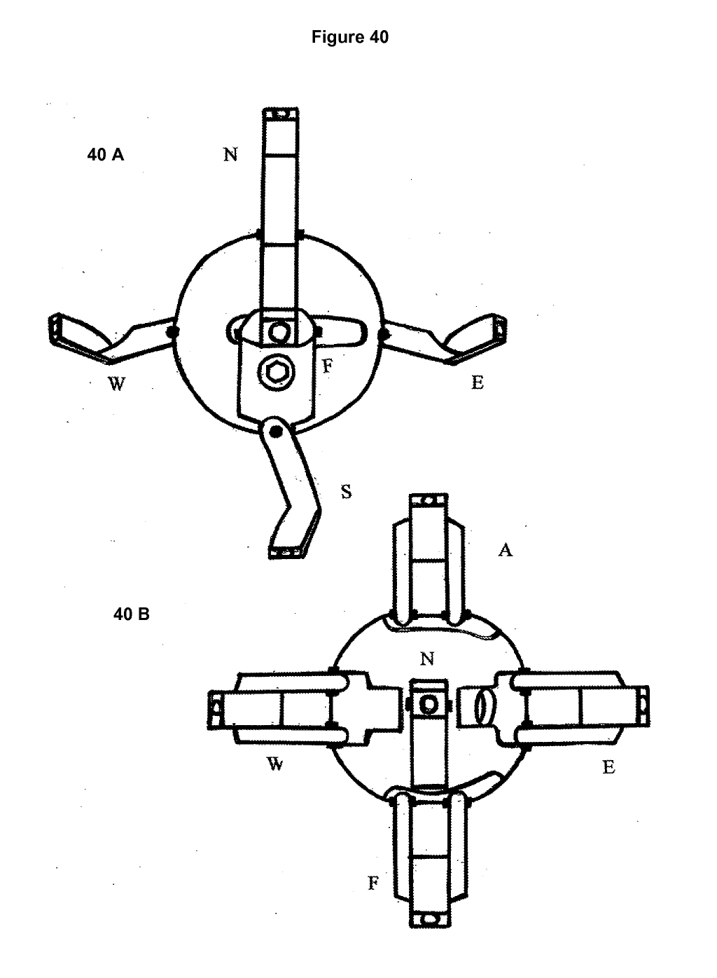

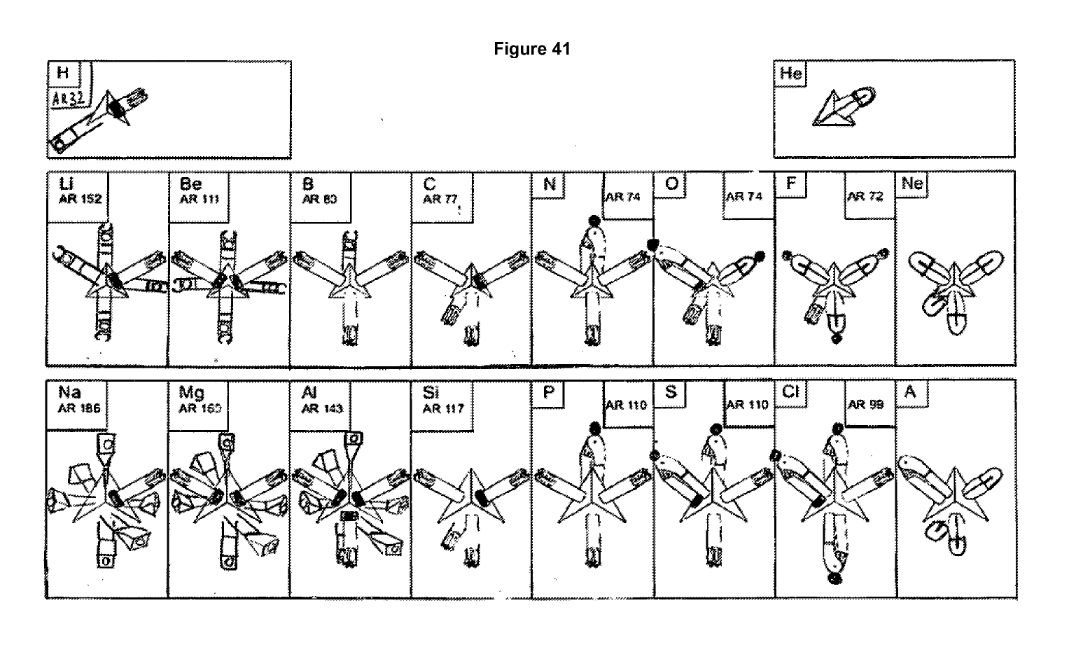

Two more tiltable basic-atomic-body-connecting-elements are connected at the the poles of the basic-atomic-body. In the out-folded state then e.g. a tetragonal bipyramidal configuration is obtained (like in FIG. 40 in the preferred embodiment with basic-atomic-body-coupling-recesses represented). At the representation of the metallic state all basic-atomic-body-connecting-elements are folded in and are therefore not able to form a connection to electron-pair-connecting-elements in this configuration. Starting of from the tetragonal-bipyramidal configuration (like e.g. in FIG. 39 in the preferred embodiment with basic-atomic-body-coupling-recesses represented) the tetragonal-planar configuration is obtained by folding in both basic-atomic-body-connecting-elements north (N) and south (S) on the poles. Starting from the tetragonal-planar-configuration (39) the tetrahedral configuration (like e.g. in FIG. 38 with the preferred embodiment with basic-atomic-body-coupling recess represented) is obtained by folding in half way of the four basic-atomic-body-connecting-elements of the equatorial circumference. Alternatingly two of the four basic-atomic-body-connecting-elements of the equatorial circumference are folding into direction of the south-pole and the north-pole of the basic-atomic-body. Because of this construction it is possible, that all possible coordination-bindings (complexes) can be represented by the six basic-atomic-body-connecting-elements which are located on the basic-atomic-body. At sodium it is for example possible to represent the hydrate-shell in its correct coordination. At the aluminum it is possible to represent either the amphoteric tetragonal bipyramidal as well as the amphoteric tetragonal configurations. In the same way the complexes of the other d-group metals and metals can be represented with their different configurations.

The present invention concerns therefore representations of basic-atomic-bodies, at which the basic-atomic-body-representation shows a number of plus-charge-connecting-elements that correspond to the number of valence-electrons and further shows one up to six out-foldable basic-atomic-body-connecting-elements. The basic-atomic-body-representation is preferably shaped like a ball. The plus-charge-connecting-elements are preferably plus-charge-plugs and further preferred recesses for intake of a corresponding minus-charge-plug in shape of a male/female plug-connection. The out-foldable basic-atomic-body-coupling-plugs serve as binding-positions for the electron-pair-coupling-plugs and can be folded out in different configurations, so that the forms of coordination, tetragonal-bipyramidal, trigonal-bipyramidal, tetrahedral, tetragonal-planar and trigonal-planar can be represented. Basic-atomic-body-coupling-plugs and electron-pair-coupling-plugs represent a kind of male/female plugs, which cannot be connected to other types of plugs, like e.g. plus-charge-plugs, minus-charge-plugs and neutral-plugs (null-plugs).

### 7.3 IONIC-BONDS

Also ionic-bonds are in the molecular-building-set according to the invention representable with the described electron-pair-connecting-elements and the basic-atomic-body-connecting-elements. In salt-crystals or more generally phrased in ionic-crystals, the same electron-pair-connecting-elements and basic-atomic-body-connecting-elements can be used to form a mutual connection and to represent an ionic-crystal. At the ionic-bond no charge-conjunction of minus-charge-connecting-elements and plus-charge-connecting-elements can be obtained. E.g. sodium-chloride: The sodium-ionic-representations and the chloride-ionic-representations can connect to each other thereby via electron-pair-connecting-elements and basic-atomic-body-connecting-elements, without doing a charge-conjunction. At the sodium-ionic-representation the plus-charge-connecting-element is visible and at the chloride-ionic-representation the minus-charge-connecting-element is visible. Ions can thereby be also arranged in the sodium-chloride-gird via electron-pair-connecting-elements and basic-atomic-body-connecting-elements.

### 7.4 TECHNICAL EXECUTION OF ELECTRON-PAIR-CONNECTING-ELEMENTS AND OF BASIC-ATOMIC-BODY-CONNECTING-ELEMENTS

In a preferred embodiment all connections of electron-pair-representations to basic-atomic-bodies are performed with the same connecting-, adherence- or plugging-principle. For the mutual connection of electron-pair-connecting-elements and basic-atomic-body-connecting-elements a male/female connecting-, adherence- or plugging-principle is used. Preferably in the molecular-building-set according to the invention such connections are represented as ball-coupling. At which the side of the electron-pair-representation preferably carries the ball and the side of the basic-atomic-body preferably carries the ball-holder. Like described above the electron-pair-representations are equipped with electron-pair-coupling-ball in shape of a ball of ball-coupling-link for coupling with the electron-pairs. The completely filled body can be made of different materials and is preferably made of plastic, hard-rubber or metal. The ball-coupling-link at the outer end of the electron-representation is recognizable as pivoting-coupling-link (FIG. 23, 27, 29). The pivoting-plug carries on the other side a radical-neutral-connecting-element and is in its middle with a pin hooked into a clevis. The ball is therein connected to the outer end of a closed electron-pair-representation.

In the preferred embodiment the distances are chosen that way, that the plugging together of the basic-atomic-body-coupling-recess with the electron-pair-coupling-plug represents the true to scale distance of a hydrogen-bridge, a Lewis-acid-connection, a complex-binding or of a ionic-crystal e.g. the O—H-hydrogen-bridge-representation is at the chosen scale of the example in this document 13 cm long, what in this scale corresponds to roughly 208 pm.

The preferred embodiment is constructed that way, that the resulting distances in the representations for coordination-bindings, hydrogen-bridges and Lewis-acid-base-bindings are made up of the effective individual-partial distances of the electron-pair-connecting-elements and basic-atomic-body-connecting-elements of the atomic-representations of the corresponding chemical elements and leads to true to scale total-distances. The individual effective partial distances of the electron-pair-connecting-elements and as well of the basic-atomic-connecting-elements vary between the different atomic-representations of different chemical-elements.

The mutual connection of electron-pair representations and basic-atomic-bodies is represented preferably by a ball-coupling. This connecting-principle is well able to bind the ligands spatially arbitrarily variable according to rotation and binding angle. The basic-atomic-body-coupling-recesses preferably consist of a rubber-block or plastic-block which has a hollow-ball-shaped recess, which can take in the electron-pair-coupling-balls of the electron-pair-representations. The recess is tapering towards the top so that the ball can only be inserted into the excavation by stretching of the narrowing of the rubber or of the plastic and thereby a fixation is obtained.

Thereby the size the recess shell be chosen that way, that the ball is clamped and angle-adjustments and rotation of the connected atomic-representation can be fixated. Alternatively the basic-atomic-body-coupling-recesses could be made of one block of flexible plastic with a recess, which allows the insertion and fixation of the electron-pair-coupling-ball. Alternative materials of the electron-pair-coupling could be metal, wood or other materials.

Besides the preferred construction at which the ball on the electron-pair and the recess is connected on the atomic-body via pins, the female recess could as well be interchanged and at the electron-pairs and the basic-atomic-body-coupling-plugs thus be represented by coupling-balls.

Another preferred embodiment is the representation of the electron-pair-connecting-elements and the basic-atomic-body-connecting-elements by magnetic attraction with north-pole and south-pole of magnets. At which the electron-pair-connecting-elements always carry the same pole and the basic-atomic-body-connecting-elements also carry the opposite pole.

In the same way are besides the preferred embodiments also any other possible male/female-connecting-, plugging- and adherence-principles thinkable, like e.g. hook-loop-fastener with hooks on one side and loops on the corresponding other faces or e.g. the gecko-adherence-principle with suction-cups and faces on each of the opposite sides.

Besides the preferred embodiment by a pivoting-element could the different, but at least two states, be obtained by other technical solutions. In a further preferred technical solution the basic-atomic-body-connecting-element is connected to a pin, which can be shifted in and out in a recess in the basic-atomic-body. In the preferred way thus two or more defined shifting-positions are obtainable, so that the pin cannot be completely taken out or be removed. In the one state the pin is shifted into the atomic-body and the basic-atomic-body-connecting-element is in this state not able to form a connection. In another state the pin is shifted out of the basic-atomic-body for the desired distance and the basic-atomic-body-connecting-element is able to form a connection.

### 8.0 LEGEND

FIG. 1 shows a radical-neutral-connecting-element in its preferred embodiment of a radical-neutral-plug form the top. The preferred partition with 6 pins which are arranged with identical distances shaped like a annulus in a circle can be recognized. The recesses between the pins are of about the same size like the pins itself. The pins are tapering towards the middle of the connecting axis.

FIG. 2 shows the radical-neutral-plug in a perspective view. The preferred partition of the radical-neutral-plug with six pins is recognizable, which enables the insertion of six positions of a second radical-neutral-plug which is shifted by 30 degree.

FIG. 3 shows the representation of a typical covalent chemical bond, at which two radical-neutral-plugs are plugged into each other and thus a binding electron-pair—is represented. Because in this embodiment always six possibilities exist to connect radical-neutral-plugs with each other, it is possible to adjust the angle between the with each other connected atoms in 60 degree-steps and e.g. staggered and eclipsed conformation respectively boat- and chair-forms can be represented.

FIGS. 4 and 5 show that the lower part of the recess is slimmer and hexagonally shaped, so that the minus-charge-plug can be plugged in six different positions which are always turned by 60 degrees. Because of this the plugged-in electron has in relation to the other coordination-positions and binding-possibilities in FIGS. 4 and 5, represented by three tubes, always one of six different possible orientations.

FIGS. 6, 7 and 8 show an electron-representation in the preferred embodiment with a radical-neutral-plug as radical-neutral-connecting-element and a minus-charge-plug as minus-charge-connecting-element.

In FIG. 8 you can see the electron-representation from a side-view, consisting of a radical-neutral-plug, a flexible linking-element and a minus-charge-plug. Both the radical-neutral-plug and the minus-charge-plug have a C₆-rotational-symmetry. Because of this it is possible to plug the detachable electron-representation into the plus-charge recesses in all six different positions of the C₆-rotational-symmetry which differ by 60° and the pins of the radical-neutral-plug thus always sit in the identical defined three-dimensional angle-orientation. In FIG. 6 one can see the radical-neutral-plug of the detachable electron-representation from the top with its six pins. In FIG. 7 one can see the minus-charge-plug of the electron-representation from the bottom with its hexagonal geometry in the lower part of the pin.

FIG. 9 shows a carbon-atom-representation with its four identical electron-representations A, B, C and D. As it is visible from the four different views, onto the face of the different electron-representations A, B, C and D, all four, radical-neutral-plugs A, B, C and D are installed in that way, that they have always the same angle-direction in relation to their six pins in relation to the respectively three other electrons.

Thereby it is recognizable, that the side-edge of the pins is pointing towards the middle of each of the three other outer-electrons.

FIG. 10 shows two identical carbon-atom-representations V and U with four radical-neutral-plugs each. The radical-neutral-plugs are installed on the carbon via a flexible binding-element, in that way that the pins of the radical-neutral-plug are not pointing with their middle towards their own other three electron-representations, but the pins are instead 15° shifted pointing with their side-edges towards the middle of the other own electron-representations. Because of this two identical carbon-atoms are not mirror-symmetrical to each other and it is not possible to transform them by mirroring on a mirror-plane M into each other, but they are like two right hands to each other, what in chemistry is called chiral.

In the same way are all single radical-neutral-plugs, which are firmly connected to a basic-atomic-body are chiral, if two carbon-atom-representations are aligned in the same way like in FIG. 10. In the carbon-atom-representations V and U the radical-neutral-plugs Va and Ua are not mirror-symmetrical, because they are chiral identical to each other. Only because of this chiral construction the in FIG. 11 represented conformers in staggered and eclipsed conformation can be formed. To enable a simpler connecting of the radical-neutral-plugs to each other the circular disc, with its fixed pins for plugging the radical-neutral-plugs into each other, is rotatably fixed to the head of the radical-neutral-plug.

FIG. 11 shows, how different plugging together of two carbon-atoms (here only implied as basic-atomic-body-fragment) with three different substituents each (A,B,C) and (X,Y,Z) at the position of the radical-neutral-plug six different steric conformers can be formed. Three of these (11(A), 11(C), 11(E)) are staggered and three (11(B), 11(D), 11(F)) are eclipsed.

FIGS. 12 and 13 show different thinkable possibilities of radical-neutral-plug-geometries, at which the pins are annularly arranged on a circular disc. The rest of the atomic-representation is only fragmentarily implied. FIG. 12 shows a radical-neutral-plug with three pins in radical-neutral-geometry. FIG. 13 shows a radical-neutral-plug with only two pins.

FIG. 14 shows the pattern of the diameter of the middle of the plugging-contact of the pins of two radical-neutral-plugs, which are plugged together with their pins. The black dots represent the pins of the radical-neutral-plug of one side and the rimmed dots represent the pins of a radical-neutral-plug that comes from the other side. In this the pins are arranged in a pattern of equilateral triangles. At this arrangement the pins of one side are always clutched by three pins of the opposite side. Every third position of the base area remains free at plugging together. In the figure to be recognized as positions, which have neither a black dot nor a rimmed dot.

FIG. 15 shows the pattern of the diameter of the middle of the plugging-contact of the pins of two radical-neutral-plugs which are plugged together with their pins. The black dots represent the pins of the radical-neutral-plug of one side; the rimmed dots represent the pins of the radical-neutral-plug of the other side. The pins are herein arranged in a pattern of a chessboard, at which the black areas carry the pins and the white areas stay empty and are able to take in the pins of the plug that is plugged in. In this arrangement the pins of one side are always clutched by four pins of the opposite side.

FIGS. 16-18 show, how by means of the binding of two radical-neutral-plugs with their effective proportionate binding-distances the effective true to scale binding distance is created. Therein it has to be noticed, that the effective proportionate binding distance is only the length up to the middle of the pins of the radical-neutral-connecting-element as it is recognizable in the drawing.

At 16 4.8 cm (accord with 77 pm) of the carbon (C) add up with 4.4 cm (accord with 70 pm) of the nitrogen (N) to a total of 9.2 cm (accord with 147 pm).

At 17 4.15 cm (accord with 66 pm) of the oxygen (O) add up with 2.0 cm (accord with 32 pm) of the hydrogen (H) to a total of 6.15 cm (accord with 98 pm).

At 18 4.8 cm (accord with 77 pm) of the carbon (C) add up with 4.8 cm (accord with 77 pm) of the other (C) to a total of 9.6 cm (accord with 154 pm).

The FIG. 19-22 show, how by means of the formation of multiple bonds between two identical atomic-representations (CC) (FIGS. 19 and 20) or multiple-bond-representations between different atomic-representations (CN) (FIGS. 21 and 24) the true to scale binding-distances are achieved, what results from the contraction of the bending of the flexible binding-tubes between the basic-atomic-body-centers.

At the CC-Double-bond-representation in FIG. 19 the distance of the CC-single-bond-representations like shown in FIG. 18 is contracted from 9.6 cm to 8.4 cm. This is true to scale in accordance with the real bond-length of the CC-double-bond of 133 pm. The four out-sticking electron-representations that are not involved in the double-bond-representation (indicated as a bar) are all precisely lying in one plane.

At the CC-triple-bond-representation in FIG. 20 the distance of the CC-single-bond-representations like shown in FIG. 18 is contracted from 9.6 cm to 7.5 cm. This is true to scale in accordance with the real bond-length of the CC-triple-bond of 120 pm. The two out-sticking electron-representations that are not involved in the triple-bond-representation (indicated as a bar) are all precisely lying in one line.

At the CN-Double-binding-representation in FIG. 21 the distance of the CN-single-bond-representations like shown in FIG. 16 is contracted from 9.2 cm to 8.1 cm. This is true to scale in accordance with the real bond-length of the CC-double-bond of 129 pm. The four out-sticking electron-representations that are not involved in the double-bond (indicated as a bar) are all precisely lying in one plane.

At the CN-triple-bond-representation in FIG. 22 the distance of the CC-single-bond-representations like shown in FIG. 16 is contracted from 9.2 cm to 7.1 cm. This is true to scale in accordance with the real bond-length of the CN-triple-bond of 115 pm. The two out-sticking electron-representations that are not involved in the triple-bond (indicated as a bar) are all precisely lying in one line.

The in FIGS. 23-30 shown electron-pair-representations are represented with connecting-elements of the preferred embodiment. Electron-pair-connecting-elements as electron-pair-coupling-plug with ball, radical-neutral-connecting-elements as radical-neutral-plug with C₆-rotational-symmetry and minus-charge-connecting-elements as minus-charge-plug with C₆-rotational-symmetry.

In the FIGS. 23, 27-29 an electron-pair-representation at a basic-atomic-body is recognizable, which consists of a detachable electron-representation, which is in FIGS. 23 and 28 plugged into the plus-charge-recess and an electron-representation with a pivoting-plug which is firmly connected to the basic-atomic-body and which carries a radical-neutral-plug as radical-neutral-connecting-element on one side and an electron-pair-coupling-ball as electron-pair-connecting-element on the other side. The pivoting-plug is clipped in with a bolt a holder profile which functions as a revolute-joint. The holder profile is connected to the basic-atomic-body via a flexible binding tube.

In FIG. 23 a closed electron-pair-representation is visible. Both the radical-neutral-plugs are plugged together and the minus-charge-plug is plugged into the recess of the plus-charge-plug. The ball of the electron-pair-coupling-plug is directed outwards and can if necessary be connected to the according recess of the basic-atomic-body-coupling-plug (FIG. 36).

In FIG. 24 a closed electron-pair-representation is visible, which neither owns a radical-neutral-plug and cannot be opened at this position nor owns a minus-charge-plug and plus-charge-plug, which can be detached. Only the ball of the electron-pair-coupling-plug is existing and functional. Such an electron-pair-representation is e.g. part of the preferred fluorine-atomic-representation. It is only enabled for bonds with the basic-atomic-body-coupling-plugs which are firmly connected to the basic-atomic-bodies and which is not enabled for the formation of ionic or covalent bond-representations.

In FIG. 25 a closed electron-pair-representation is visible, which owns neither radical-neutral-plugs and cannot be opened at this position, nor owns a minus-charge-plug and a plus-charge-recess which could be detached. As well does no electron-pair-couplings-ball exist. Such an electron-pair-representation is part of e.g. noble gases like neon. Such a free electron-pair is enabled to no chemical reaction whatsoever.

In FIG. 26 a closed electron-pair-representation is visible. Both the radical-neutral-plugs are plugged together and the minus-charge-plug is plugged into the recess of the plus-charge-plug. The ball of the electron-pair-coupling-plug is not existing. Such an electron-pair-representation is e.g. existing in the preferred representation of Argon and Krypton. Such electron-pair-representations can not connect to a the according recess of a basic-atomic-body-coupling-plug of another basic-atomic-body. Both radical-neutral-plugs can be separated and than e.g. together form a double-bond with the two radical-neutral-plugs of an oxygen-atom-representation.

In FIG. 27 the electron-representation is taken out and the pivoted-plug with its radical-neutral-plug turned to the top. On the basic-atomic-body the recess of the plus-charge-plug that represents the positive charge is recognizable. The unconnected radical-neutral-plug represents thereby a free radical. In combination this would be the representation of a radical-cation and a single electron.

In FIG. 28 the electron-pair-representation is divided at the position of the radical-neutral-plug. The single electron thereby is plugged with the minus-charge-plug into the recess of the plus-charge-plug. Both radical-neutral-plugs are then e.g. able to form together with both radical-neutral-plugs of an oxygen-atom-representation a double-bond.

In FIG. 29 an electron-pair-representation is visible which is connected to the radical-neutral-plugs and divided at the minus-charge-plug and the plus-charge-plug. The pivoted-plug is folded outwards, so that the detachable electron-representation which is connected thereon is directed outwards with the minus-charge-plug.

In FIG. 30 a representation is visible that is based on FIG. 29. At the same time a hydrogen-cation-representation is plugged with the recess of the plus-charge onto the minus-charge-plug of the outwards folded electron-representation. A positive charge remains at the basic-atomic-body, represented by a recess of a plus-charge-plug at the basic-atomic-body. An analog situation exists e.g. in the representation of ammonium-ions or hydroxonium-ions, if a hydrogen-cation-representation binds to the electron-pair-representation of an ammonia-molecule-representation or respectively water-molecule-representation. The positive charge is represented localized at the basic-atomic-body of the central atom of the molecule-representation.

In the FIGS. 31-33 a hydrogen-atom-representation of the preferred embodiment with a plus-charge-recess as plus-charge-connecting-element and a basic-atomic-body-ball-couplings-recess as basic-atomic-body-connecting-element is shown.

In the FIGS. 31 (frontal-view) and 32 (side-view) always one hydrogen-atom is represented, consisting of a basic-atomic-body with in-folded basic-atomic-body-coupling-plug and a plugged in detachable electron-representation. The radical-neutral-plug sticks out up to the front in true to scale length.

In FIG. 33 a ball-shaped basic-atomic-body of the hydrogen-atomic-representation with the recess of the plus-charge-plug that represents a positive charge is visible (comparable the FIGS. 34 and 35 at which in contrast the basic-atomic-body-coupling-pug is folded out). The basic-atomic-body-coupling-plug is folded in into the basic-atomic-body. The detachable electron-representation (comparable FIG. 8) that belongs to the hydrogen-atomic-representation is pulled out and shown below of the basic-atomic-body of the hydrogen-ion-representation.

FIG. 34 (front-view), 35 (side-view) show a ball-shaped basic-atomic-body of the hydrogen-atomic-representation without the electron representation which actually belongs to it (like in FIGS. 32 and 31) and therefore with a round recess of the plus-charge-plug below, which symbolizes a positive charge. Such a positively charged basic-atomic-body of a hydrogen atom-representation accords with an Ht ion. An electron-representation, as represented in FIG. 8, can almost completely be inserted into the recess of the plus-charge-plug, so that only the radical-neutral-plug is still looking out (comparable to FIGS. 31 and 32 at which the basic-atomic-body-connecting-element is folded in). This construction of the hydrogen-atom-representation is necessary, because the hydrogen has a significantly shorter proportionate binding-length in comparison to the other elements. Above it is visible that the folded out basic-atomic-body-connecting-element in the preferred embodiment of the basic-atomic-body-coupling-plug with recess (in the case of the hydrogen-atomic-representation the folded out basic-atomic-body-connecting-element symbolizes a part of a hydrogen-bridge), which is able to be connected to the ball of an electron-pair-coupling-plug of an electron-pair-representation. The out-foldable basic-atomic-body-coupling-plug with recess consists in the preferred embodiment out of a flexible rubber-block with a ball-shaped recess, which can take in the ball of the electron-pair-coupling-plug and hold it. There are two pins firmly connected to the rubber-block which at the other end of both sides are clipped onto a bolt as a pivoted-link. The bolt that is used as a pivoted link, is connected to the basic-atomic-body with a bend holder, which is then on both sides connected to the basic-atomic-body.

FIG. 36 shows a representation of a hydrogen-bond consisting of an electron-pair-representation with electron-pair-coupling-plug with a ball (comparable FIG. 23) and a hydrogen-basic-atomic-body with out-folded basic-atomic-body-coupling-plug with recess, and recess of the plus-charge-plug without electron (comparable FIGS. 34 and 35). the representation of a hydrogen-bridge is formed by the ball-coupling of these two elements. All together in this example a length of 13 cm results between the basic-atomic-body-centers, what accords with the chosen true to scale dimension of the example of 206 pm, what accords well with the real length of a hydrogen-bridge.

In the FIGS. 37-40 as an example a three times positively charged aluminum-ion-representation which is based on a ball-shaped basic-atomic-body is represented with three plus-charge-connecting-elements in the preferred embodiment as plus-charge-plugs with recesses and with six basic-atomic-body-connecting-elements in the preferred embodiment as basic-atomic-body-coupling-plugs with recesses is shown. The three plus-charge-recesses are located at the positions F (front), A (aft), E (right). The positions W (left), N (north) and S (south) have no plus-charge-recesses.

These plus-charge-recesses are enabled to do a charge-conjunction with minus-charge-plugs of detachable electron-representations. In some cases it is possible that aluminum-atoms with such electrons (respectively metals in general) can build covalent bonds with other metals or non-metals. In case of an aluminum-atom-representation, which is formed out of an aluminum-ion-representation by on-plugging of three electron-representations under charge-conjunction, would result a proportionate covalent bond-length of a covalent aluminum-bond-representation of 7.8 cm, what accords with true to scale covalent-radius of the example of aluminum of 125 pm.

All six positions F (front), A (aft), E (right), W (left), N (north) and S (south) do all have an out-foldable basic-atomic-body-coupling-plug with recess for the connection to balls of the electron-pair-coupling-plugs of electron-pair-representations.

The recess of the basic-atomic-coupling-plugs of the metal-atomic-representations in the preferred embodiment is constructed in the same way like the recess of the hydrogen-atomic-representations: A rubber- or plastic-block has a hollow ball-shaped recess which is able to connect to the balls of the electron-pair-coupling-plug of electron-pair-representations and which clutches those after plugging in a way that different directions can be adjusted, that are fixed by the clutching. The rubber- or plastic-block with the recess has on two sides two pins firmly connected to it. On the other side both pins are connected to the basic-atomic-body via a bolt that functions as a pivoted link, in a way that the basic-atomic-body-coupling-recesses can be folded into different positions. In the position which is folded into the direction of the basic-atomic-body like in FIG. 37 presented the basic-atomic-body-coupling-recesses are not able to connect to electron-pair-coupling-balls.

Besides of the position that is folded towards the basic-atomic-body the basic-atomic-body-coupling-recesses can be folded into different orientations, in such a way that various steric geometries are possible (FIG. 38-40).

In FIG. 37 (shown in two perspectives front view from F and north view from N) all basic-atomic-body-coupling-plugs are folded onto the basic-atomic-body. In this configuration the recesses of the basic-atomic-body-coupling-plugs are not able to connect to electron-pair-representations. For metals this can be e.g. the case in the gas-phase or in the metallic state. The example shows the six basic-atomic-body-coupling-plugs as example for the arrangement of coordination-binding-positions of metal-atomic-representations in general.

In FIG. 38 (shown in two perspectives front view from F and north view from N) the same aluminum-ion-representation like in FIG. 37 is shown with four of the basic-atomic-body-coupling-recesses F (front), A (aft), E (right), W (left), are folded out in the way that a tetrahedral configuration is created, if electron-pair-representations are connected to the four out-folded basic-atomic-body-coupling-recesses. Two of the electron-pair-coupling-recesses are folded onto the basic-atomic-body (N (north) and S (south)) and are not available for bindings to ligand-representations.

In FIG. 39 (shown in two perspectives front view from F and north view from N) the same aluminum-ion-representation like in FIG. 37 is shown with four of the basic-atomic-body-coupling-recesses F (front), A (aft), E (right), W (left), are folded out in the way that a tetragonal planar configuration is created, if electron-pair-representations are connected to the four basic-atomic-body-coupling-plugs. Two of the basic-atomic-body-coupling-plugs are folded onto the basic-atomic-body (N (north) and S (south)) and are in this representation not available for bindings to ligand-representations.

In FIG. 40 (shown in two perspectives front view from F and north view from N) the same aluminum-ion-representation like in FIG. 37 is shown with all six of the basic-atomic-body-coupling-recesses F (front), A (aft), E (right), W (left), N (north) and S (south) are folded out in the way that a tetragonal-bipyramidal configuration is created,

FIG. 41 shows exemplarily atomic-representations of the first, second and third period in a preferred embodiment with tetrahedrons as basic-bodies and the centered on the tetrahedron-positions located firmly connected electron-representations and detachable electron-representations with radical-neutral-plugs each, which have radical-neutral-plugs and minus-charge-plugs with the preferable C₆-rotational-symmetry, electron-pair-representations with electron-pair-connecting-elements which are represented as electron-pair-coupling-plugs with balls and basic-atomic-body-connecting-elements, which are represented as basic-atomic-body-coupling-plugs with recesses.

FIG. 41 (H): at the top left of FIG. 41 a hydrogen-atomic-representation is shown (further hydrogen-atomic-representations can be found in FIGS. 31-36). The tetrahedral-shaped basic-atomic-body has a plus-charge-plug which is represented as recess, through which an electron-representation is plugged. Without the electron-representation a ball-shaped or tetrahedral basic-atomic body with a hole is obtained, at which the recess symbolizes the positive charge. The electron-representation sticks as a radical-neutral-plug out of the tetrahedral basic-body in true to the scale length. On the opposite side of the recess a basic-atomic-body-coupling-plug with recess is represented which is connected to one or many pins, pipes or tubes, which can represent a hydrogen-bridge. The basic-atomic-body-ball-coupling-recess itself is a hollow ball-shaped recess in a rubber- or a plastic-block. At the basic-atomic-body-ball-coupling-recess on the side two pins are firmly connected, which are again firmly connected to the basic-atomic-body. In a preferred embodiment the pins including the basic-atomic-body-ball-coupling-recess can be folded onto the tetrahedral basic-atomic-body via a hinge (Look as well at the representations in FIGS. 31-35).

FIG. 41 (C): The carbon-atomic-representation is represented with a tetrahedral basic-atomic-body, at which the firmly connected electron-representations always extend from the tetrahedral-positions, which have each a radical-neutral-plug at the other end. For the user it is thus directly obvious that a carbon-atomic-representation can represent 4 covalent bonds.

FIG. 41 (N): The nitrogen-representation is represented with tetrahedral-shaped basic-atomic-body, at which the firmly connected electron-representations are located on three of the tetrahedral-positions. Thus for the user it is obvious that nitrogen-atomic-representations are able to represent three covalent bonds, if furthermore one electron-pair-representation remains at the nitrogen-atomic-representation. Furthermore it is recognizable, that the three connected atomic-representations are not trigonal-planar but pyramidaly arranged. Furthermore it is obvious, that under charge-disjunction of the electron-pair-representation, the nitrogen-atomic-representation is even able to represent 4 covalent bonds (according to the FIGS. 29 and 30). Finally the user recognizes as well, that the ball of the electron-pair-coupling-plug of the electron-pair-representation in the plugged-together state can be connected to a recess of a basic-atomic-body-coupling-plug, what in case of a metal-atomic-representation can symbolize a complex-bond with a metal. The example of nitrogen clarifies demonstratively, how many information the user can already collect from one building block of the molecular-building-set.

FIG. 41 (O): Two of the six outer electrons are represented by firmly connected electron-representations, that contain one radical-neutral-plug and four of the six outer electrons are represented by electron-pair-representations. One of the electron-pair-representations is build according to the type of FIG. 24 and thus not able to represent covalent bonds. The other electron-pair-representation is build according to the type of FIGS. 23,27-29. Therefore it is possible to build H₂O-molecules or H₃O⁺-ions, but no H₆O-molecules.

FIG. 41 (Ne): Neon is exemplarily as well represented by a tetrahedral basic-atomic-body. Because the 8 outer electrons are basically not able to represent covalent chemical bonds, they are not represented by radical-neutral-plugs but by electron-pair-representations of the type of FIG. 25, which do not possess an electron-pair-connecting-element, which cannot disconnect the radical-neutral-plugs and which cannot do charge-disjunction. The neon-atomic-representation thus shows 4 electron-pair-representations of the type of FIG. 25, which are each mostly centrally positioned on the tetrahedral-positions and which can not be used for the formation of covalent chemical bonds or other interactions. Because of this the observer can recognize, that some of the noble gases are chemically absolutely inert.

FIG. 41 (Al): (see as well FIG. 37 until 40 of an aluminum-ion-representation with description). The aluminum-atomic-representation consists preferably of a ball-shaped or tetrahedral basic-atomic-body with three plus-charge-plugs with recess, which are located in the center of each tetrahedral-position of the basic-atomic-body. In these recesses of the plus-charge-plugs there are minus-charge-plugs of three detachable electron-representations inserted (according to the electron-representation of FIG. 8). If these electron-representations are removed, three plus-charge-plugs with recess remain in the basic-body and an Al³⁺-ion is obtained. On other tetrahedral-positions no plus-charge-plug with recess is placed.

Onto six positions of the tetragonal-bipyramid (according to FIG. 40) basic-atomic-body-coupling-plugs with recess on the pivoted links are connected, which can move into all kind of possible sterical configurations, among others as well as the tetrahedral configuration (as shown in FIGS. 37-40).

FIG. 41 (S): At sulfur two of the six outer electrons are represented by firmly connected electron-representations that contain one radical-neutral-plug and the remaining four outer electrons are represented by two electron-pair-representations according to the type of FIG. 23, 27 until 29. If the radical-neutral-plugs of the electron-pair-representations remain connected, we are dealing with a sulfur-atomic-representation with only to chemical binding-possibilities as could be e. g. found in SF₂. Is one radical-neutral-plug-connection of one electron-pair-representation opened it results in a sulfur-atomic-representation with 4 chemical binding-possibilities and one closed electron-pair-representation as could be e.g. found in SF₄. Are on the other hand both radical-neutral-plug-connections of both electron-pair-representation opened, it results in a sulfur-atomic-representation with six binding-possibilities as could be e.g. found in SF₆ or SO₃. In addition sulfur with the balls of the electron-pair-coupling-plugs of the electron-pair-representations is able to connect to recesses of basic-atomic-body-coupling-plugs and thus able to represent hydrogen-bridges, complex-bindings and lewis-acid-basis-bonds.

FIG. 41 (Cl): The element-representations of the third period do basically have a similar structure as in the second period.

One of the seven outer electrons is represented by a firmly connected electron-representation which contains a radical-neutral-plug and six of the seven outer electrons are represented by electron-pair-representations. The three electron-pair-representations are build according to the type of FIG. 23, 27-29. Therefore it is possible to build HCl-molecules or H₂Cl⁺-ions, but through opening of three electron-pair-representations at the radical-neutral-plugs as well F₇Cl-molecules.

1.-15. (canceled)

16. Molecular-building-set comprising electron-representations and basic-atomic-body-representations, at which an electron of a covalent bond is represented by a radical-neutral-connecting-element with a C₃ₙ-symmetry, in which n is a whole number from 1 to 20 and each connecting-element of this type can be connected to each connecting-element of the same type.

17. Molecular-building-set according to claim 1, at which an electron-representation consists of one connecting-element with at least one C₃ₙ-symmetry and one minus-charge-connecting-element in shape of a male/female connecting-element.

18. Molecular-building-set according to claim 1, at which an electron-representation of a covalent bond is represented by a connecting-element with a C₃ₙ-symmetry and n is a whole number from 1 to 4.

19. Molecular-building set according claim 1, at which a radical is represented by a C₃ₙ-radical-neutral-connecting-element, a positive charge is represented by a plus-charge-connecting-element, a negative charge is represented by a minus-charge-connecting-element and a chemical interaction is represented by an electron-pair-connecting-element and a basic-atomic-body-connecting-element, at which the C₃ₙ-radical-neutral-connecting-element is a connecting-element-type, which can be connected to each other connecting-element of this type, at which the plus-charge-connecting-element and the minus-charge-connecting-element are two connecting-element-types of a first male/female connecting-element-combination and at which the electron-pair-connecting-element and the basic-atomic-body-connecting-element are connecting-element-types of a second male/female connecting-element-combination.

20. Molecular-building set according to claim 1, at which the connecting-element-combination consisting of a plus-charge-connecting-element and a minus-charge-connecting-element is a connecting-element-contact that consists of a pin and a recess, a magnet with north- and south-pole, a hook- and loop-fastener with hooks and loops, a gecko-adherence with suction-cups and faces, a connection of a hook and eye, a plus-minus-plug-connection or another male/female connection principle.

21. Molecular-building set according to claim 1, at which the connecting-element-combination of an electron-pair-connecting-element and a basic-atomic-body-connecting-element is a connecting-element-contact consisting of a pin and a recess, a plug-connection of a ball and a ball-holder, a magnet with north- and south-pole, a hook-and-loop-fastener with hooks and loops, a gecko-adherence with suction-cups and faces, a connection of hook and eye, a plus-minus-plug-connection or another male/female connecting-principle.

22. Molecular-building set according to claim 1, at which the connecting-element-combination consisting of two C₃ₙ-radical-neutral-connecting-elements is a connecting-element-contact consisting of two connecting-elements with pins and recesses each for insertion of the pins of the respectively other connecting-element, or a neutral-hook-and-loop-fastener with loops and hooks on each of both faces of the neutral-hook-and-loop-fastener, or a neutral-magnet-connection which has north-poles and south-poles on each of both magnets, or a neutral-gecko-adherence-plug with suction-cups and adherence-faces on each of both faces of the neutral-gecko-adherence-plug, or a bayonet-lock-tube-coupling with interlocking rails on both parts of the bayonet-lock-tube-coupling or another neutral connecting- or adherence-principle.

23. Molecular-building set according to claim 1, at which the C₃ₙ-radical-neutral-connecting-element has pins and recesses between the pins, at which the recesses serve for the insertion of the pins of the second radical-neutral-connecting-element and the pins extend along the longitudinal axis of the plug-connection of both radical-neutral-connecting-elements.

24. Molecular-building set according to claim 1, at which the C₃ₙ-radical-neutral-connecting-element is shaped as a circular disc with thereon vertically arranged pins.

25. Molecular-building set according to claim 1, at which an electron pair-representation which is located at a basic-atomic-body-representation and which is enabled to do chemical reactions is represented by two with each other connected C₃ₙ-radical-neutral-connecting-elements, which are part of two electron-representations, which are connected or linked to the same basic-atomic-body-representation.

26. Molecular-building set according to one of the claim 25, at which a basic-atomic-body-representation of an element has as many C₃ₙ-radical-neutral-elements as this element has valence-electrons.

27. Molecular-building-set according to claim 25, at which the electron-pair-representation on the basic-atomic-body-representation is represented by two with each other connected C₃ₙ-radical-neutral-connecting-elements which are connected to a basic atomic-body-representation with a connection of a plus-charge-connecting-element and a minus-charge-connecting-element.

28. Molecular-building set according to one of the claim 27, at which a minus-charge-connecting-element is characterized by a round, a triangular, tetragonal, a pentagonal, a hexagonal, a non-agonal, or dodecagonal pin that is marked with a color and a plus-charge-connecting-element which is represented by a round, a triangular, a tetragonal, a pentagonal, a hexagonal, a non-agonal, or dodecagonal recess for insertion of the pin that is marked with a color.

29. Electron-representation as part of the molecular building set, at which a free electron is represented by a radical-neutral-connecting-element connected with a minus-charge-connecting-element, at which the radical-neutral-connecting-element is a connecting-element that can be connected to each other radical-neutral-connecting-element and the minus-charge-connecting-element is a male/female connecting-element that can only be connected to the corresponding counter-connecting-element, the plus-charge-connecting-element, of the basic-atomic-body.

30. Representation of a pair of electrons according to claim 29, at which the representation of an electron-pair contains an electron-representation that, is connected to a second electron-representation of the represented electron-pair via a radical-neutral-connecting-element and is connected to the plus-charge-connecting-element of the basic-atomic-body via a minus-charge-connecting-element.
